(19) United States
(12) Patent Application Publication
(10) Pub. No.: US 2016/0062055 A1
(43) Pub. Date: Mar. 3, 2016

(54) FIBER OPTIC SOLUTIONS FOR MIGRATION BETWEEN DUPLEX AND PARALLEL MULTI-FIBER SOLUTIONS ALLOWING FOR FULL FIBER UTILIZATION

(71) Applicant: Corning Optical Communications LLC, Hickory, NC (US)

(72) Inventors: William Julius McPhil Giraud, Azle, TX (US); David Joseph Hessong, Hickory, NC (US); Diana Rodriguez, Fort Worth, TX (US); Brian Keith Rhoney, Hickory, NC (US)

(21) Appl. No.: 14/840,313

(22) Filed: Aug. 31, 2015

Related U.S. Application Data
(60) Provisional application No. 62/043,794, filed on Aug. 29, 2014.
(60) Provisional application No. 62/043,797, filed on Aug. 29, 2014.
(60) Provisional application No. 62/043,802, filed on Aug. 29, 2014.
(60) Provisional application No. 62/132,872, filed on Mar. 13, 2015.

(51) Int. Cl. G02B 6/38; G02B 6/44

(52) U.S. Cl. CPC G02B 6/3879; G02B 6/3897; G02B 6/4453; G02B 6/4471

(57) ABSTRACT

Fiber optic equipment that supports 8-fiber MPO configurations that enable migration between duplex transmission and 8-fiber parallel transmission is disclosed. The fiber optical equipment comprises a hybrid fiber optic module having a front end and a rear end and a linear array of single fiber optical connector adapters arranged in a width direction at the front end, each of the single fiber optical adapters having a front side and a rear side. The hybrid module also comprises a front multi-fiber adapter at the front end, the front multi-fiber adapter having a front side and a rear side and a rear multi-fiber adapter at the rear end of the module, the rear multi-fiber adapter having a front side and a rear side. The module also comprises a plurality of optical fibers optically connected between a rear side of each of the array of single fiber optic adapters and the front side of the rear multi-fiber adapter, wherein a multi-fiber connector can be connected to either the rear side of the front multi-fiber adapter to enable an optical connection with a multi-fiber connector connected to the front side of the front multi-fiber adapter, or to the rear side of the rear multi-fiber adapter to enable optical connections with a plurality of single fiber optic connectors connected to the linear array of single fiber fiber optic connector adapters.

### PRIORITY APPLICATION

This application claims the benefit of priority under 35 U.S.C. §119 of U.S. Provisional Application Ser. Nos. 62/043,794, 62/043,797, and 62/043,802, all of which were filed on Aug. 29, 2014 and U.S. Provisional Application Ser. No. 62/132,872, which was filed on Mar. 13, 2015, the content of each of which is relied upon and incorporated herein by reference in its entirety.

### FIELD

The present disclosure relates to optical fiber connection assemblies, and more particularly, to optical fiber connection assembly hardware and modules for a base-8 fiber solution.

### BACKGROUND

There are two dominant transmission forms used in data centers for fiber cabling today. A duplex (e.g., 2 fiber) solution uses dedicated transmit and receive optical channels paired together and a parallel multi-fiber solution (e.g., 8-fiber solutions) that transmits signals using multiple optical channels and recombines the multiple optical channels for transmitting at faster speeds. For instance, a parallel 100-Gigabit link may be transmitted along ten parallel 10-Gigabit lanes with the multiple 10-Gigabit signals being recombined from the parallel channels. Many customers desire to move back and forth between these different transmission forms at different locations in the network depending on network management requirements and link costs at different protocol speeds. Existing parallel solutions require an MTP type connector, which is designed to hold 12 fibers.

Likewise, current duplex solutions also deploy 12-fiber MPO trunk cabling along with MPO/LC breakout modules. In the duplex solutions the plurality of optical channels of the MPO connecter are broken out into individual optical channels using modules with LC connections. Consequently, all of the optical channels can be accessed as LC ports at the front of the module. However, these network solutions do not allow the flexibility to easily migrate the system from a duplex transmission to a parallel transmission solution and vice- versa. Further, fiber utilization rates for the 12-fiber optical networks can be encountered if other fiber counts are needed for the network such as 8-fiber solutions, either 4 fibers must be left dark or conversion modules must be employed, either of which may add cost, complexity and attenuation to the network systems.

Existing solutions for migration from a duplex transmission to a parallel transmission contemplate the cumbersome replacement of current MPO-LC modules with an MPO panel. However, there is also a need to easily migrate back to a duplex transmission when desired. This migration can provide challenges and result in extensive down time for the migration. For example, users are cabling cabinets in the data center space without prior knowledge if duplex or parallel transmission would be required in that cabinet (based on servers placed in that cabinet). In addition, new transceiver technology is always evolving in the market; thus a particular data rate today that might require parallel cabling could be replaced by a new duplex transceiver in the future at the same data rate. Thus, there is a need for flexibility in cabling and network infrastructure that allow the network operator an easy way to migrate between duplex and parallel transmission and vice versa at locations in the optical network

### SUMMARY

The application discloses end-to-end solutions for 8-fiber MPO connector, not the standard 12-fiber connections used in the industry today (the MPO connector such as a MTP connector itself could be a new 8-fiber molded ferrule with only 8 holes or only load 8 fibers in the current 12 fiber connector ferrule configuration and is a BASE-8 configuration). Although the concepts are discussed relative to chassis having a 1-U rack space footprint, all of the concepts may be expanded for example to chassis having a 4-U rack space footprint with the same densities, but a quadrupling of the number of optical connections supported. It is contemplated that other dimensions of housings (e.g., 5-U, 8-U, etc.) may be used without departing from the scope of the present disclosure.

The equipment, illustrated generally in FIGS. 1A-5, contemplates trunk cables using eight fibers per MPO connector. The trunk cables could utilize 8-fiber subunits to which an MPO connector can be directly connectorized. This solution also contemplates new fiber optic equipment such as eight fiber modules to allow up to 48 fibers in a ⅓ U tray utilizing LC duplex connectivity. In other words, the fiber optic equipment such as modules, panel assemblies and hybrid modules may have a height that is ⅓ U-space or less for dense tray stacking in a chassis. Equipment trays using the BASE-8 modules and other fiber optic equipment for migrating from parallel to duplex transmissions are also disclosed.

The components and optical network solution disclosed offers several advantages compared with conventional optical network solutions having a BASE-12 configuration. For instance, the equipment disclosed provides 100% fiber utilization, and maintains link attenuation performance when converting from a duplex solution to a parallel 8 fiber solution.

The fiber optic equipment provides a simple migration path between duplex and 8-fiber parallel links, by using a small MPO increment that matches up directly with the number of transceiver channels so that the migration between duplex and parallel links for transmission can happen while disrupting fewer duplex clients during migration.

Another embodiment, illustrated generally in FIGS. 6 and 7, contemplates extending the MPO on the back of an MPO/LC module via a pigtail-like design, allowing it to be interconnected in the front plane. This MPO pigtail of the module or a MPO jumper would be routed through the hardware (via a pass through channel design in the panel assembly or hardware) into the front end for connection in a multi-fiber adapter. The MPO based trunks would terminate in a panel assembly in the fiber optic equipment, thus the MPOs would be available for 8-fiber links in the front end of the fiber optic equipment. When 2-fiber links are required, the pigtailed modules would be installed and the leg passed through the hardware to the front plane to be interconnected to the MTPs in the panels. When the 2-fiber links are no longer required, the pigtails of the module would be unplugged, freeing up the 8f ports (the pigtail modules could remain in the housing as a future path back to 2f connectivity). Likewise, the interconnection from the module to the panel assembly may be made using a MPO jumper cable.

An additional application for the pigtailed module is for spine and leaf architectures where often 40G ports are used to create a 10G mesh to allow for a more servers in the network. This would allow a patch field to be created and the mesh to be completed with jumpers.

Another embodiment contemplates an eight fiber pigtailed module, which can help solve two problems. The first is the desire to run parallel ports like high density duplex ports. An application example of this is the ability to run 40G ports like (4) 10G ports. One of the main challenges in the application is that the structured cabling the multi-fiber port must be broken down into duplex connectors in the structured cabling. Current applications include buying 8 fiber harnesses and plugging them into panels. This solution can be solved better by providing an 8 fiber pigtailed module that can be plugged directly into the parallel port and present as LC connectors at the piece of hardware. Each LC breakout module would represent a single parallel 4-channel parallel port (instead of the current 12f breakout panel that must represent 1.5 parallel ports, hence not a clean/logical breakout of the port).

Components, fiber optic equipment and assemblies disclosed may also support switching between parallel and duplex links from the front side of chassis, tray or optical hardware. Again, the pigtail would extend the current MPO from the backplane and pass through the panel assembly to interconnect on the front plane to the trunk. This achieves the goal of presenting both the parallel and duplex ports at the front plane with no need to move the trunk cable connector (in the rear) when converting between duplex and parallel. In addition, no additional loss is introduced in the link.

This solution offers several advantages:
The ability to switch between duplex and parallel link form the front of a fiber optic housing. The backplane MPO cabling is able to stay in place and the network operator can easily migrate between duplex and parallel links from the front of the housing.
A clean and simple breakout of high fiber count parallel ports that are being operated to act like higher density lower speed ports. An application of this is operating parallel 40G ports like 4 duplex 10G ports. This 8-fiber pigtailed module would allow that to happen, where the MPO pigtail would plug directly into the port and LC duplex connectors would be presented at the front end of the hardware such as tray, chassis or fiber optic equipment to allow the 10G ports to run to the desired location in the data center. This flexibility contributes to the value of running parallel ports as slower speed high density duplex ports.

Another embodiment, illustrated generally in FIGS. 8-10C, contemplates a hybrid module having a single BASE-8 MPO adapter, so that network operators can migrate from the MPO/LC module to the MPO adapter when transitioning to parallel optical circuits. This hybrid module allows the network operator to reserve a slot in the equipment/hardware such as a tray if and when they would need to go back to duplex transmission.

The concept behind this disclosure is to create a combination duplex and parallel hybrid module that would allow a customer to transition between the different transmissions by simply moving the connector of the trunk cable between locations of the hybrid module. One alternative to this approach would be to move the MPO connector from the trunk from a MTP/LC module into an MTP panel.

The advantage of this hybrid module would be the ease of planning and cabling migration. In one chassis embodiment, each slot in the tray would have a single MPO connector dedicated to that slot position in the tray. That MPO would be loaded in the rear of the module to breakout into LC connectivity for duplex transmission (creating 4-6 duplex links) or placed in the MPO adapter at the front plane to allow for a single parallel channel. As equipment is placed in the cabinet and the data rate and transmission technology is determined, the user would move each MTP per slot either in the duplex or parallel position based on the application. Thus, the network operator does not have to replace modules with panels on Day 1 or Day 2 because both options are available in each module slot on Day 1.

Additional features and advantages will be set forth in the detailed description which follows, and in part will be readily apparent to those skilled in the art from the description or recognized by practicing the embodiments as described in the written description and embodiments hereof, as well as the appended drawings.

It is to be understood that both the foregoing general description and the following detailed description are merely exemplary, and are intended to provide an overview or framework to understand the nature and character of the embodiments. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIGS. 1A is a view of a BASE-8 fiber optic module according to one embodiment;

FIGS. 1B and 1C depict a MPO panel and an LC module, respectively, having the BASE-8 configuration;

FIGS. 2A and 2B are perspective and top views, respectively, of an equipment tray adapted to support six (6) fiber optic modules (or panels) shown in FIG. 1A per unit width of the tray;

FIGS. 3A-3D are respective perspective, front, top, and side views of the equipment tray of FIGS. 2A and 2B disposed in a 1-U space chassis;

FIG. 4 illustrates a comparison of the BASE-8 fiber optic module and equipment tray of FIGS. 2A-2B compared to a BASE-12 fiber optic module and equipment tray;

FIG. 5 illustrates a combination of BASE-8 and BASE-12 equipment trays disposed in a 1-U space chassis;

FIG. 6 illustrates a fiber-optic panel assembly having a pair of front multi-fiber adapters and a pass-through channel configured to receive at least one optical multi-fiber cable therethrough;

FIG. 7 illustrates an equipment tray supporting the fiber optic panel assemblies of FIG. 6 along with the BASE-8 fiber optic modules of FIG. 1A;

FIG. 8 illustrates a hybrid fiber optic module with a 8-fiber optic module portion and a multi-fiber pass through portion disposed in a BASE-12 form factor for mounting into a BASE-12 sized equipment tray;

FIG. 9 illustrates an equipment tray supporting the hybrid fiber optic module of FIG. 8;

FIGS. 10A-10C illustrate respective perspective, front, and top views of the equipment tray of FIG. 9 disposed in a 1-U space chassis;

FIGS. 10D and 10E illustrate respective perspective front views of different 4-U chassis implementations, consistent with certain disclosed embodiments;

FIGS. 11A and 11B illustrate a perspective view of the rear of an alternate embodiment of a BASE-8 fiber optic module and a perspective view of the front of an alternate embodiment of a BASE-8 fiber optic panel, consistent with certain disclosed embodiments;

FIG. 12 illustrates a perspective view of an exemplary mounting rail for use on a tray, in accordance with certain disclosed embodiments;

FIG. 13 illustrates a perspective view of an exemplary tray equipped with the exemplary mounting rails of FIG. 12, consistent with certain disclosed embodiments;

FIGS. 14A-14C illustrate perspective front, top, and close-up views, respectively, of an exemplary tray, in accordance with certain disclosed embodiments;

FIG. 15 illustrates a top view of an exemplary chassis assembly having a lower tray in an extended (“slid-out”) position and an upper tray in a fully retracted (“housed”) position, consistent with certain disclosed embodiments;

FIGS. 16A and 16B provide top views of alternate embodiments of metallic supporting structures used in respective implementations of the equipment trays, in accordance with certain disclosed embodiments;

FIG. 17 illustrates a perspective front isometric view of an exemplary equipment tray having rail guides and jumper routing guides, consistent with certain disclosed embodiments;

FIG. 18 illustrates a perspective side view of an exemplary jumper routing guide, in accordance with certain disclosed embodiments;

FIGS. 19A, 19B, and 19C illustrate a perspective front view (for BASE-12), a schematic wiring diagram (for BASE-12), and a schematic wiring diagram (for BASE-8), respectively, of exemplary LC to MTP module with an MTP port “tap” capability;

FIGS. 20A and 20B illustrate a respective perspective front view and schematic wiring diagram, respectively, of an exemplary BASE-12 and BASE-8 MTP to MTP module with an MTP port “tap” capability; and

FIGS. 21A, 21B, and 21C illustrate a perspective front view (for BASE-12), a schematic wiring diagram (for BASE-12), and a schematic wiring diagram (for BASE-8), respectively, of exemplary LC to LC port “tap” capability.

### DETAILED DESCRIPTION

The application discloses BASE-8 modules, fiber optic panel assemblies, and hybrid fiber optic modules for mounting in equipment trays that can be mounted in a movable fashion to a chassis. The assemblies disclosed provide the ability to easily and quickly migrate an optical network between duplex transmission and 8-fiber parallel transmission. The BASE-8 configurations are contrary to the installed BASE-12 optical networks that are widely deployed. Further, the BASE-8 components and assemblies can improve fiber utilization rates when requiring quick and easy migration path between duplex and parallel transmission in an optical network.

Conventional solutions include replacing the current MPO/LC breakout duplex modules with MPO panels/modules when converting to 8-fiber links for parallel transmission. However, there is a need for flexibility to convert back to 2-fiber links as needed when network requirements change, such as new lower bandwidth equipment placed in cabinet, or a new technology evolving that only requires 2-fiber duplex connectivity. Hence, the ability to easily convert between duplex and 8-fiber parallel transmission systems is desired and not currently available with conventional networks. One embodiment is directed to tray for mounting fiber optic equipment having a BASE-8 configuration. For instance, the fiber optic equipment having the BASE-8 configuration could be a module, a panel assembly, a hybrid module, or other suitable fiber optic equipment.

As used herein, BASE-8 means the component supports transmission of eight optical channels and connects with 8-fiber connectors, not 12-fiber connectors. Consequently, all of the optical channels may be used for migrating between duplex and parallel transmission without having unused optical fibers. The concepts are depicted with 8-fiber ports such as MPO ports and single fiber ports such as LC ports that support single fiber connectors. Fiber optic equipment and assemblies disclosed may be secured and supported in trays, and the trays may be secured and supported in a chassis. Further, the fiber optic equipment may optionally move relative to the trays when attached thereto. Likewise, the trays may optionally move relative to the chassis when attached thereto.

This disclosure is directed to pre-terminated solutions based around using units of 8-fibers in connectors and adapters to match-up with the channels required for an 8-fiber parallel transceiver. This is in contrast to the conventional 12- and 24-fiber base solutions used in optical networks today. Included in this disclosure are trunk cables with 8-fiber units, MPO connectors or other suitable connector only populated with 8-fibers, and BASE-8 fiber optic equipment such as MPO to LC fiber optic modules, fiber optic panel assemblies and hybrid fiber optic modules.

Generally speaking, a module will include an enclosure having an internal chamber, whereas a panel assembly will not have an enclosure. A fiber harness is typically installed into the internal chamber of the module for protecting the same. Panel assemblies may be used for optical connection such as a fiber optic panel assembly comprising a front panel disposed at a front end with a linear array of fiber optic adapters arranged in a width direction in the front panel in a BASE-8 configuration. Further, the BASE-8 fiber optic equipment such as the fiber optic panel assembly or module may compactly mount into a tray using ⅙ of the tray width or less. In another embodiment, the fiber optic panel assembly has a first and second multi-fiber adapter disposed at a front end of the fiber optic panel assembly and at least one pass-through channel at the rear side. Another piece of fiber optic equipment is the hybrid fiber optic module that supports connections for eight LC connections and an 8-fiber MPO connection at the front end, and which provides a quick and easy migration node in the network.

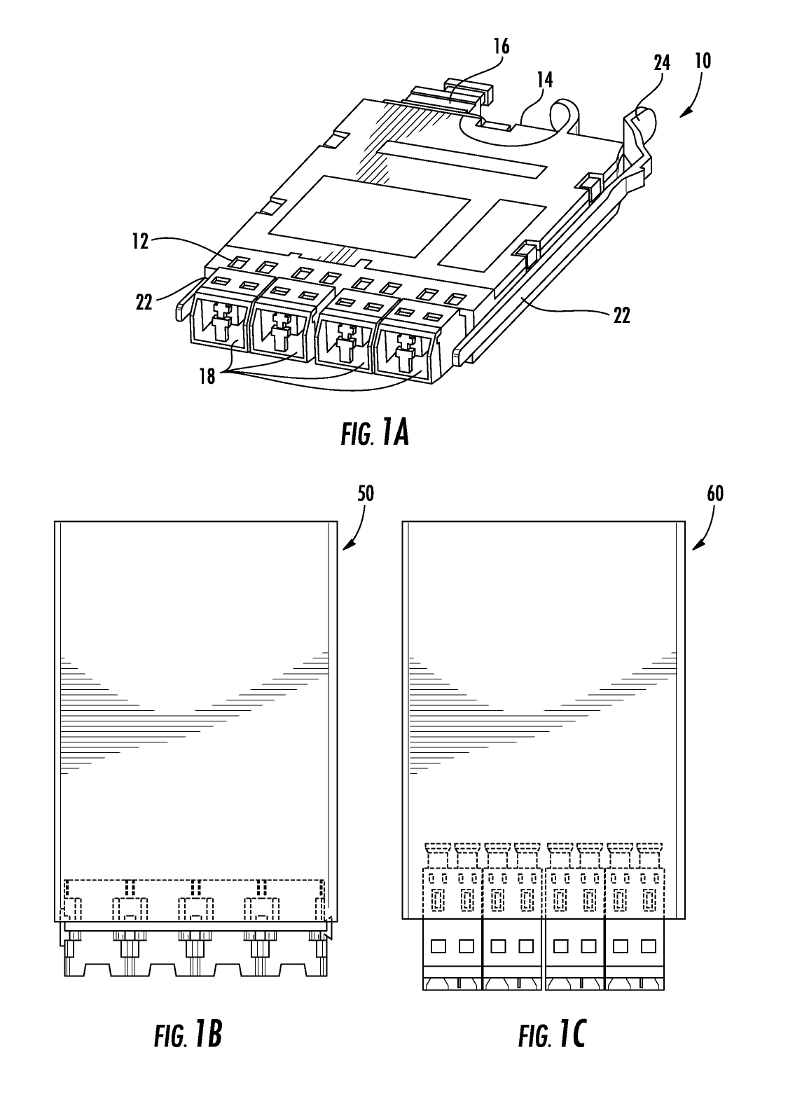

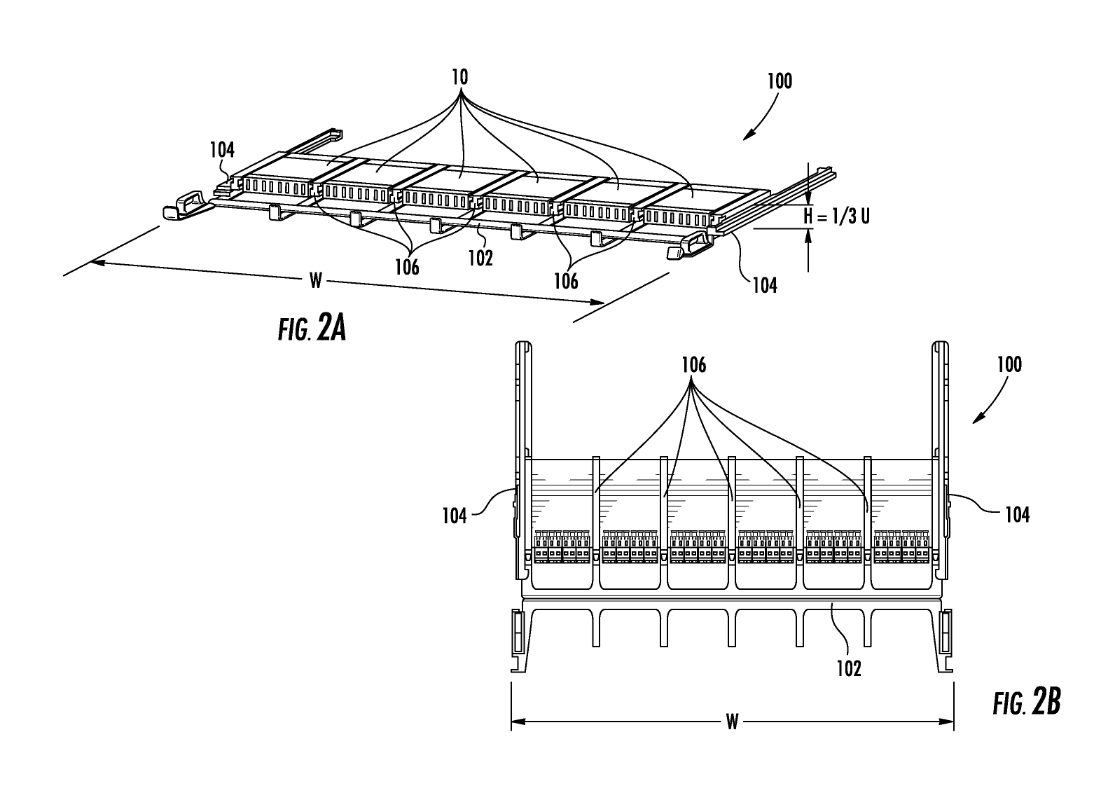

FIG. 1A depicts a BASE-8 fiber optic module 10 (hereinafter module 10) and FIGS. 2A-2B illustrate an equipment tray 100 (hereinafter tray) using module 10. FIGS. 1B and 1C respectively illustrate a BASE-8 4 port MTP panel assembly 50 and a BASE-8 LC panel assembly 60 that may also be utilized in the trays and chassis disclosed herein using the same port in the tray, thereby enabling a 24 port MPO density in a ⅓ U tray or LC-LC connectivity in the trays.

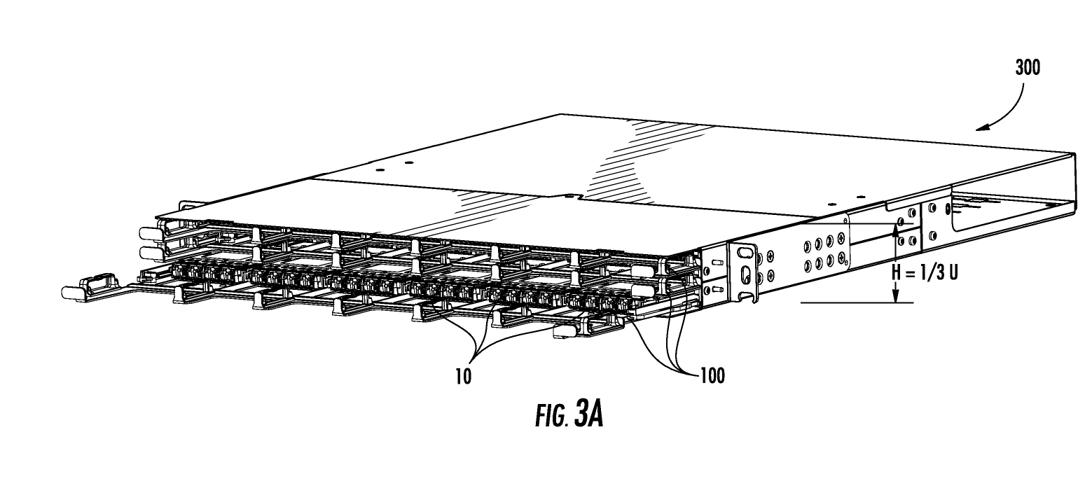

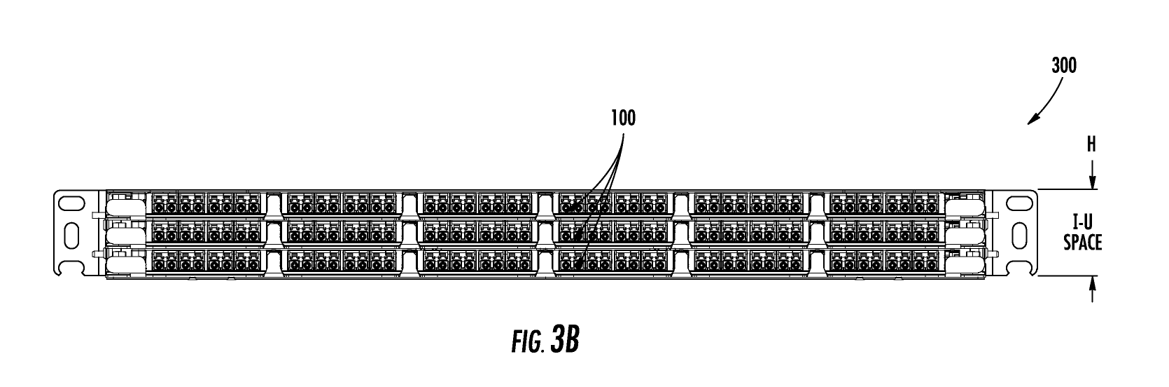

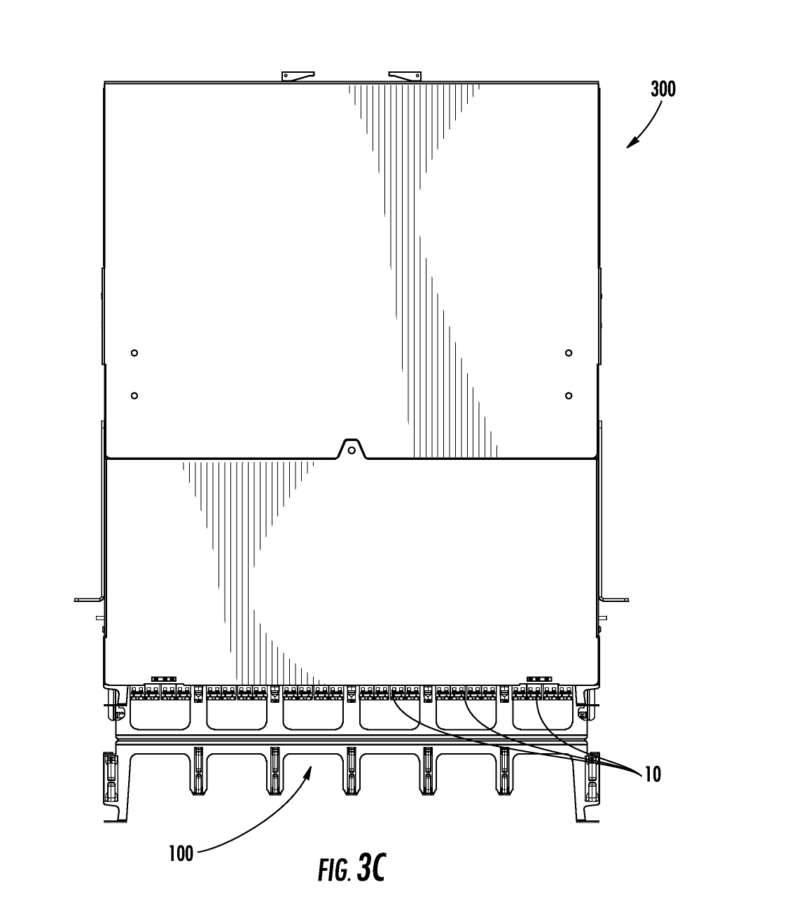

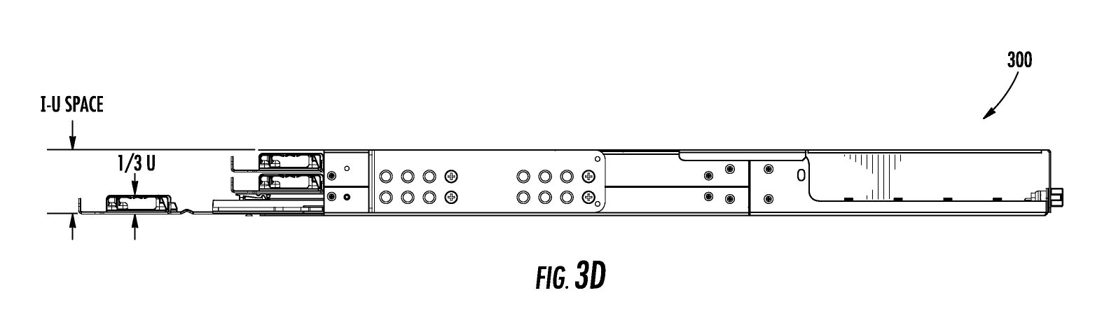

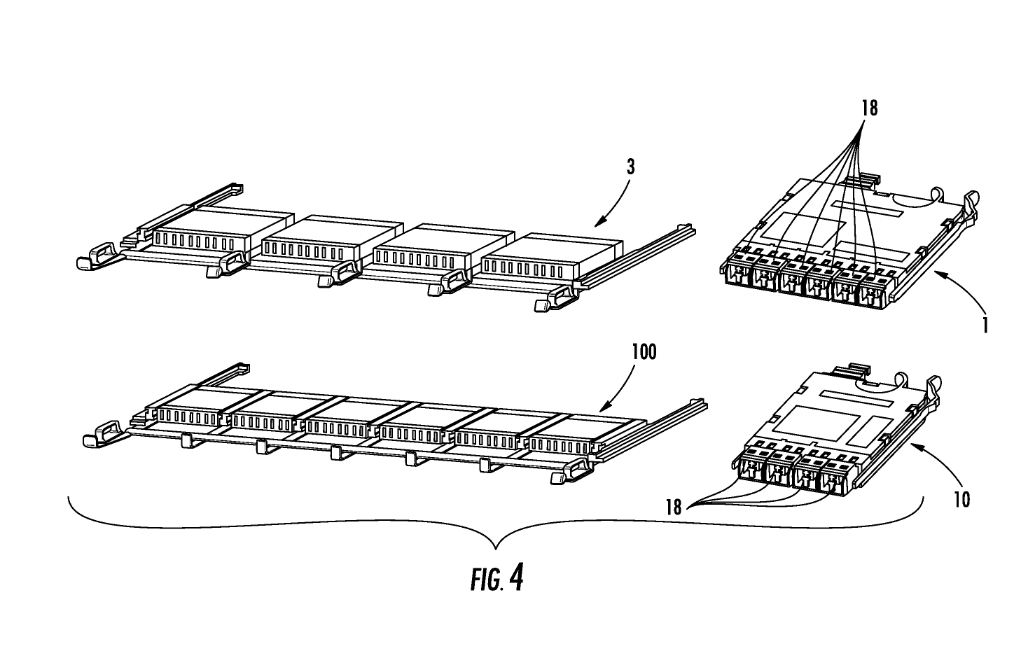

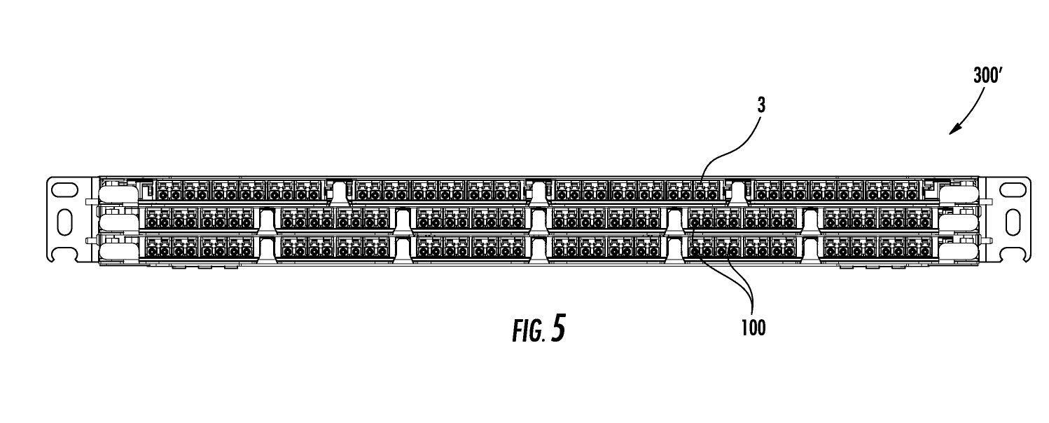

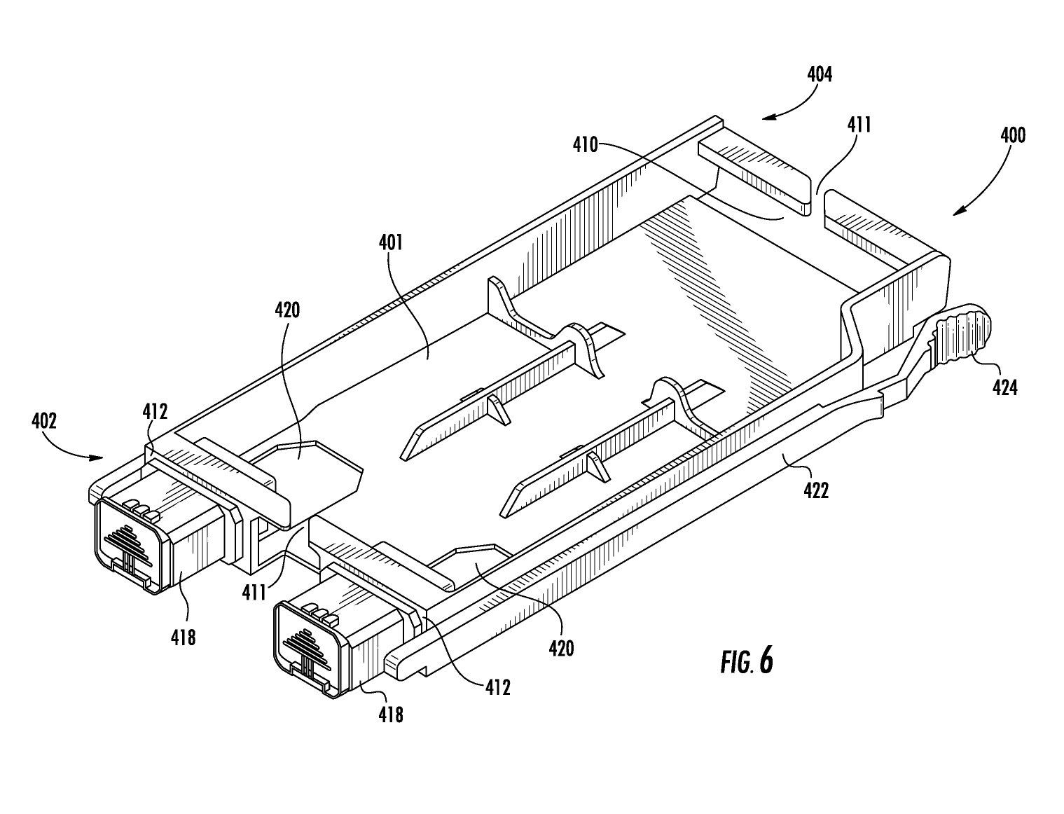

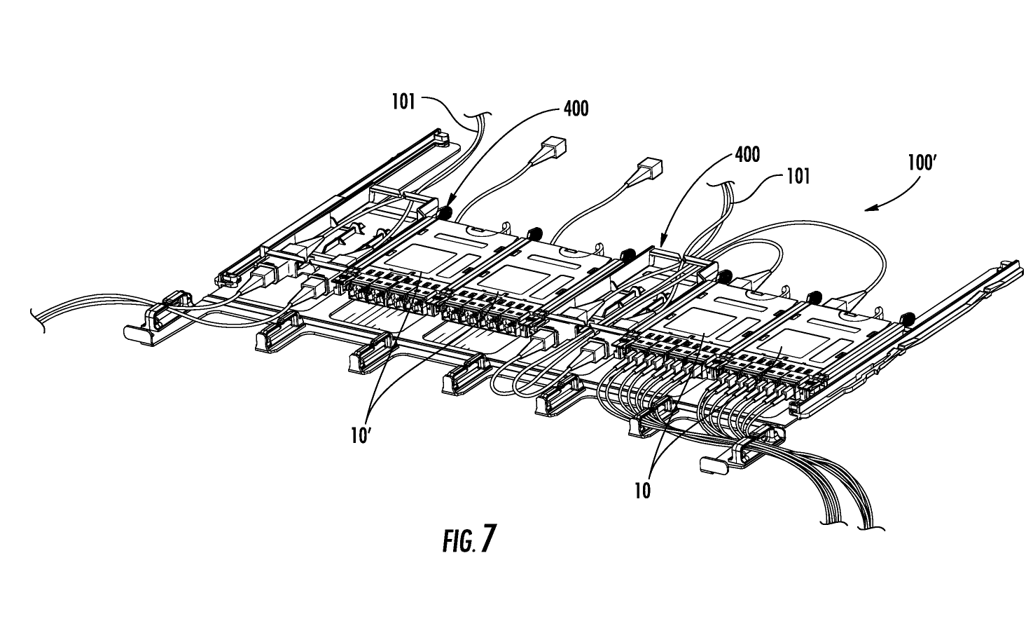

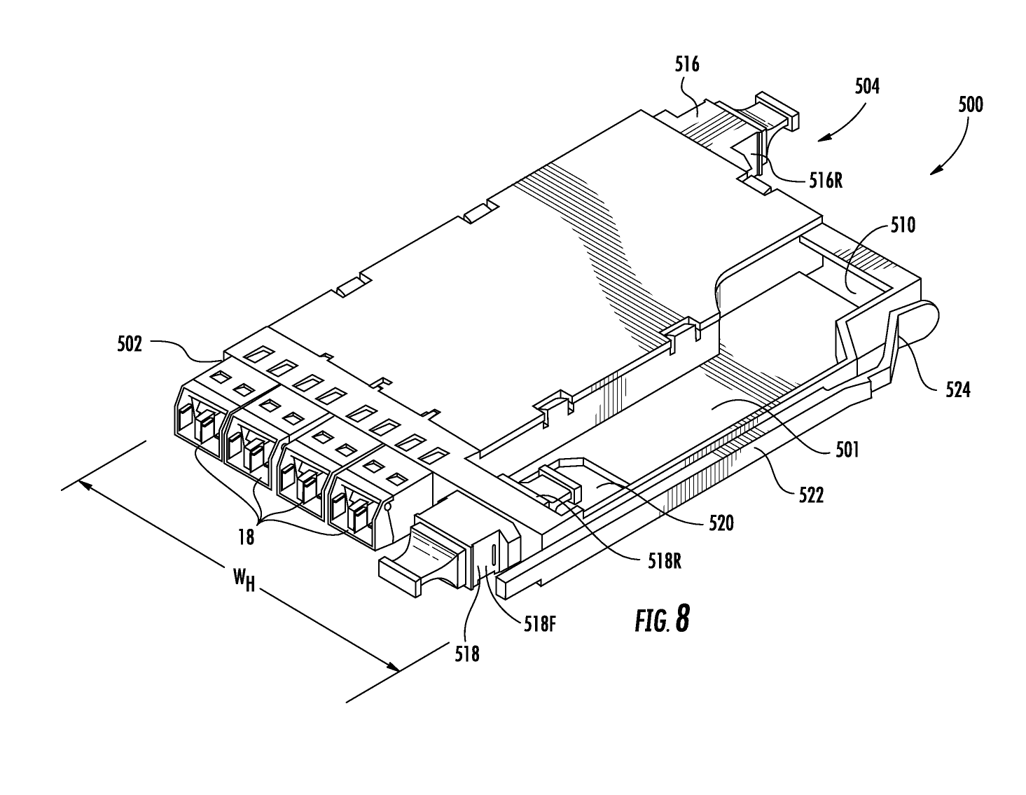

FIGS. 3A-3D depict a chassis 300 for receiving and supporting trays. Although, the use of the trays and other equipment is shown with respect to a 1-U space chassis, the concepts may be used with a larger chassis such as 2-U, 4-U, etc. FIGS. 4 and 5 depict that the BASE-8 equipment disclosed is also backwards compatible with existing installed base of chassis such as chassis 300′. FIGS. 6 and 7 depict a fiber optic panel assembly along with its use in a tray 100′. FIGS. 8-10 depict a hybrid fiber optic module along with its use in a tray and chassis for migrating from a duplex to parallel transmission by providing two different connection locations for the trunk cable connector.

FIG. 1A depicts a BASE-8 module 10 that supports eight optical connections. Module 10 has a front end 12 and a rear end 14 with a linear array of fiber optic adapters 18 disposed at the front end 12. The adapters are arranged in a width direction in the front side in a BASE-8 configuration. Adapters 18 may be LC adapters and support an optical connection between an optical harness (not visible) within the module 10. This embodiment has four duplex LC adapters for eight LCs total; however, the adapters could be ganged together in other variations such as four LCs or eight LCs.

Module 10 has an enclosure (not numbered) with an internal cavity. The harness has a plurality of optical fibers optically connected between the linear array of fiber optic adapters 18 and a rear side of the fiber optic assembly. For instance, a MPO adapter 16 is disposed at rear end 14 suitable for connection with an 8-fiber connector of a trunk cable. However, other variations of module 10 are possible such as a pigtail extending from rear end 14 for optical connection such as shown by the module 10′ in FIG. 7.

Module 10 also has rails 22 for attaching it to a tray as discussed below. Module may also optionally have a lever 24 for selectively removing it from and securing it to a tray. For instance, a latch (not numbered) is disengaged by pushing lever 24 inward to release the latch (not numbered) from a support rail of the tray. To faciliate pushing the lever 24 inwards, a finger hook (not numbered) is provided adjacent to or proximate lever 24 so the lever 24 can easily be squeezed, drawing lever 24 toward the finger hook, thereby laterally displacing latch relative to a corresponding securing mechanism associated with the support rail of the tray and allowing the module to be slidably disengaged from the tray.

FIGS. 2A-2B illustrate tray 100 for mounting fiber optic equipment. Tray 100 may be mounted in a chassis as disclosed or other suitable equipment. “Mounting” as the term is used here, refers to any component or group of componenets suitable for permanenently, semi-permanently, temporarily, and/or removably coupling tray 100 to the chassis. According to one embodiment, “mounting” may be effectuated by securing the tray 100 to the chassis using a permanent or semi-permanent fastener such as, for example, rivets, bolts, screws, or any other suitable mechanism (or combinations thereof) for fastening one structure to another. Alternatively or additionally, “mounting” may include or embodiment temporary or non-permanent solutions for securing tray 100 to the chassis. For example, in certain exemplary embodiments, mounting may be effectuated using clips, pull-tabs, removable rivets, press-clips, pine-tree type clips, push-nut fasteners, or any other type of fastener suitable for removably coupling tray 100 to chassis. “Mounting” may also include or embody any component or combinations of components suitable for slidably coupling tray 100 to the chassis. For example, tray 100 may be mounted to the chassis by way of a guide rail coupled to the chassis that, when coupled to a corresponding rail component of tray 100, supports and guides tray 100, allowing for forward-rearward translation of tray 100 relative to chassis.

Tray 100 comprises a base 102 for supporting a plurality of BASE-8 fiber optic equipment. For instance, the tray can include module 10 and/or panel assembly 400 (FIG. 6).The tray comprises one or more support rails 104 of the base 102 for movably mounting the tray 100 in a chassis. The tray also comprises a plurality of equipment support rails 106 of the base for movably mounting the plurality of BASE-8 fiber optic equipment to the tray 100. Support rails and/or the equipment support rails may be modular components or may be integrally formed with the base of the tray as desired.

Base 102 is configured to support at least five (5) pieces of BASE-8 fiber optic equipment in a width W direction. Tray 100 has a height H of ⅓ U-Space or less. The tray may support a connection density of greater than thirty-two (32) fiber optic connections, at least forty (40) fiber optic connections, and forty-eight (48) fiber optic connections per ⅓ U-space with a BASE-8 configuration.

As depicted in FIGS. 2A and 2B, the tray is configured to support at least six pieces of BASE-8 fiber optic equipment equipment in the width W direction. Thus, module 10 is configured to mount into tray 100 using ⅙ of the tray width W or less. The trays disclosed can be designed to be installable into existing installed base of chassis, thereby forming hybrid chassis having a first tray that supports BASE-8 fiber optic equipment and a second tray that supports BASE-12 fiber optic equipment such as shown by FIG. 5.

FIGS. 3A-3D depict a fiber optic equipment chassis 300 (hereinafter chassis) for receiving and supporting a plurality of trays. As shown, chassis 300 has a plurality of trays 100 mounted therein. Chassis having a plurality of trays mounted therein may support a connection density of greater than ninety-six (96) fiber optic connections per one U-space, at least one hundred and twenty fiber optic connections per one U-space, or at least one hundred forty-four (144) fiber optic connections per one U-space. Trays 100 are movably mounted in chassis 300 in a manner so they can be moved independently. Moreover, the modules may be independently movable with respect to the base of the tray. Chassis 300 includes supports for receiving support rails 104 of tray 100. U.S. Pat. No. 8,452,148 discloses independently translatable modules and trays and U.S. Pat. No. 8,538,226, each of which are hereby incorporated by reference in its entirety, discloses equipment guides and rails with stopping positions.

According to one embodiment chassis 300 may have a standard height of 1-U space for an equipment rack and has mounting structure for securing the same to a rack. According to other embodiments, chassis may have a height suitable for mounting in a different size, such as 2-U or 4-U space for an equipment rack. Chassis 300 has a ⅓ U-Space for the individual trays 100. As shown, in FIG. 3A the bottom tray 100 extends from the chassis 300 and the top two trays 100 are in a storage position. If a chassis was a 2-U space chassis it would support six (6) trays and if a chassis was a 4-U space chassis it would support twelve (12) trays. Consequently, the three trays 100 can each support up to six (6) pieces of BASE-8 fiber optic equipment for a total of eighteen (18) pieces of BASE-8 fiber optic equipment. FIGS. 3B-3D depict other views of chassis 300.

BASE-8 modules allow for the same LC duplex density to be achieved as BASE-12 trays and chassis, but advantageously allow for 8 fiber MPO's to be utilized to allow for 100% fiber utilization for migration from duplex to 8-fiber parallel transmission when using panels and MPO jumpers.

The industry solutions on the market today either require conversion modules to take the widely deployed BASE-12 and BASE-24 fiber solutions down to eight fiber increments or the use of MPO pass through panels which do not allow all of the fibers to be utilized. The embodiments and concepts disclosed herein solve the fiber count mismatch of existing structured cabling solutions with a BASE-12 configuration and provide a matched fiber count for cooperation with the transceivers. Thus, the embodiments and concepts disclosed herein allow for high-density, easy transitions along with low attenuation solutions.

FIG. 4 illustrates a comparison of module 10 and tray 100 with a conventional BASE-12 fiber optic module 1 and a BASE-12 equipment tray 3. As shown, the BASE-12 fiber optic module requires connecting 12-fibers and has adaptors supporting twelve (12) LC ports. Tray 3 only supports four (4) BASE-12 fiber optic modules 1 as shown. In one embodiment, tray 100 is similar to tray 3 so it can be installed into a common chassis that supports a hybrid configuration of BASE-8 trays and BASE-12 trays.

FIG. 5 depicts a hybrid chassis 300′ that supports a combination of BASE-8 trays 100 and BASE-12 equipment trays 3 disposed in a 1-U space chassis. Hybrid chassis 300′ provides the network operator flexibility in the optical network to make moves, adds, and changes to transmission protocol as desired while maintaining a neat and orderly cable deployment and routing for the data center.

The concepts disclosed include other BASE-8 fiber optic equipment that may be used in trays for providing the network operator more flexibility and ability to modify the optical network and make migrations of transmission protocols. FIGS. 6 and 7 show other BASE-8 fiber optic equipment for use in trays for providing flexibility to the network operator. FIG. 6 depicts a fiber optic panel assembly 400 (hereinafter panel assembly) comprising at least one front multi-fiber adapter 418 and a front end 402 of the panel assembly 400. Each multi-fiber adapter has a front side and a rear side. Each side of the adapter receives a BASE-8 connector. Panel assembly 400 comprises at least one pass-through channel 410 configured to receive at least one optical multi-fiber cable therethrough. Panel assembly 400 may be used in a BASE-8 tray and may mount into a tray using 1/6 of the tray width or less; however, it may also be sized to fit into BASE-12 tray 3 if desired. Further, the panel assembly may be a part of a chassis and occupy 1/12 of a one U-space or less, for instance the panel assembly may be part of a chassis and occupy 1/18 of a one U-space or less.

Panel assembly 400 can have other features such as finger access cutouts 420 in the panel for allowing access below the panel assembly 400 to install BASE-8 connectors to adapters 420. Pass-through channel 410 may have a cut-out 411 so that a cable can be placed into the panel assembly 400 from the top side. Further, the pass-through channel 410 may extend to the front end 402 of the panel assembly and may include a second cut-out 411 for placing cables into the panel assembly 400 from the top side. Panel assembly 400 may further include ribs for structural support, panel rails 422 for mounting in the tray, a lever 424 or other suitable structure or features. Panel assembly can be configured as a simple panel or it can have a housing 401 extending between a front panel 412 and the rear end 404 of panel assembly 400 as shown. It is possible for the housing 401 to include an enclosure if desired to form a module.

Panel assembly 400 has at least one front panel 412 where the at least one front multi-fiber adapter 418 is disposed in the front panel. In the embodiment shown in FIG. 6, panel assembly has two front panels 412 for the two (2) respective multi-fiber adapters 418. In other embodiments, the panel assembly 400 may include at least three (3) fiber optic adapters 418.

FIG. 7 shows an equipment tray 100′ supporting panel assemblies 400 along with modules 10 and modules 10′ having pigtail. Tray 100′ is similar to tray 100, but it is loaded with different BASE-8 equipment for providing the network operator configuration flexibility. Tray 100′ combines the use of modules 10 and 10′ with the use of panel assemblies 400 in a single tray for providing MPO connectivity present at the front side of the tray 100′ and chassis. Thus, tray 100′ is a hybrid tray having the module/panel assembly combined with the pass-through for use in ⅓-U space that is backwards compatible for used with existing EDGE housings available from Corning Optical Communications LLC of Hickory, N.C.

The MPOs from the trunk cable 101 are connected to the rear side of panel assembly 400 at the respective adapters 418 as shown. This ensures that the MTP is presented in the front plane of the housing to make it available for 8-fiber links. However, when the connectors are desired to be broken out into LC connectivity, the pigtail of module 10′ is passed through the center of the MTP panel and plugged in on the front side of the panel, thereby allowing the migration from parallel to duplex transmission in the optical network. The same connectivity can be accomplished using module 10 with a MPO jumper cable that attaches to the front side of the respective fiber optic adapter and the rear end of the module 10.

In use, the rear side of the at least one front multi-fiber adapter is configured to optically connect to a first multi-fiber optical cable extending from a rear end 404 of the panel assembly 400 toward the front end 402; and the front side of the at least one front multi-fiber adapter is configured to optically connect to a second multi-fiber optical cable extending from a rear end 404 of the panel assembly 400 toward the front end 402 and passing through the at least one pass through channel 410 such as shown on the right-side of tray 100′ using modules 10.

Other fiber optic equipment is also disclosed that are useful for BASE-8 configurations. FIGS. 8-10C depict a hybrid fiber optic module 500 (hereinafter hybrid module) along with its use in a tray assembly 600, which may be installed and supported in a chassis 700. As shown, hybrid module 500 fits into existing BASE-12 tray having four (4) slots for fiber optic equipment and is similar to the tray shown on the top portion of FIG. 4, except it includes hybrid modules 500.

Hybrid module 500 has both a MPO/LC breakout portion for duplex transmission as representatively shown on the left side and the other side of hybrid module having a BASE-8 MPO adapter 418. Hybrid module 500 has a front end 502 and a rear end 504. A linear array of single fiber optical connector adapter(s) 418 are arranged in a width W_{H} direction at the front end 502 and each of the single fiber optical adapters having a front side and a rear side. A front multi-fiber adapter 518 is disposed at the front end 502 and the front multi-fiber adapter has a front side 518F and a rear side 518R. A rear multi-fiber adapter 516 at the rear end 504 of the module, the adapter 516 has a front side (not visible) and a rear side 516R. The front side of the adapter 516 is disposed within an internal cavity of the enclosure of hybrid module 500. A plurality of optical fibers are optically connected between a rear side of each of the array of single fiber optic adapters and the front side of the rear multi-fiber adapter. A multi-fiber connector of a trunk cable 101 can be connected to either the rear side 518R of the front multi-fiber adapter 518 to enable an optical connection with a multi-fiber connector connected to the front side 518F of the front multi-fiber connector, or to the rear side 516R of the rear multi-fiber adapter 516 to enable optical connections with a plurality of single fiber optic connectors connected to the linear array of single fiber, fiber optic connector adapters. As depicted, hybrid module 500 comprises an enclosure (not numbered) enclosing the plurality of optical fibers within the internal cavity and protecting the same. As shown, the front multi-fiber connector 518 is disposed outside the enclosure. Thus, the hybrid module supports duplex and parallel transmission with the jumper connections at the front side of the tray or chassis for easy access and if migration is necessary the multi-fiber connector of the trunk cable merely is moved to the other adapter position of the hybrid module.

The hybrid module 500 supports a linear array of single fiber optic adapters 18 being configured as eight (8) single fiber connectors. As shown, the adapters 18 are configured as LC ports, but configurations with other connector ports are possible using the concepts. Hybrid module 500 comprises a housing 501 that partially extends between the front end 502 and the rear end 504 and includes a mounting structure. For instance, hybrid module 500 may optionally include rails 522 similar to module 10. Likewise, hybrid module may optionally include a lever 524 similar to lever 24 discussed herein.

Hybrid module 500 also comprises at least one pass-through channel 510 extending from the rear side 518R of the front multi-fiber adapter 518 to the rear end 504 of the hybrid module. Hybrid module 500 may also optionally comprise at least one cable management feature proximate to the at least one pass-through channel 510, the at least one cable management feature configured to retain the fiber optic cable in the channel. Hybrid module 500 may also comprise a finger access cutout 520 for the rear side 518R of the front multi-fiber adapter. Hybrid module 500 is configured to mount into tray 600 using ¼ of a tray width W₁₂ or less as depicted.

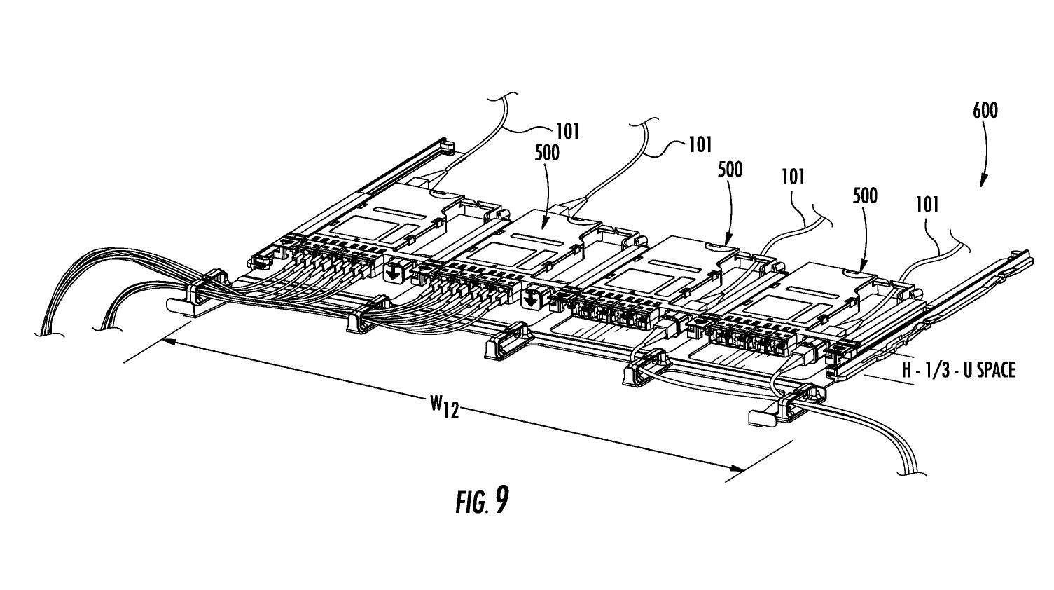

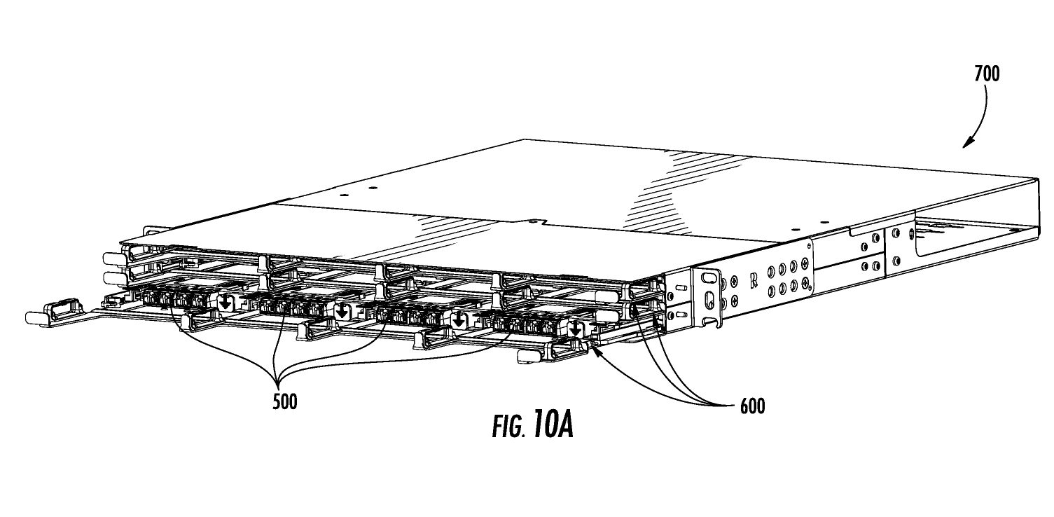

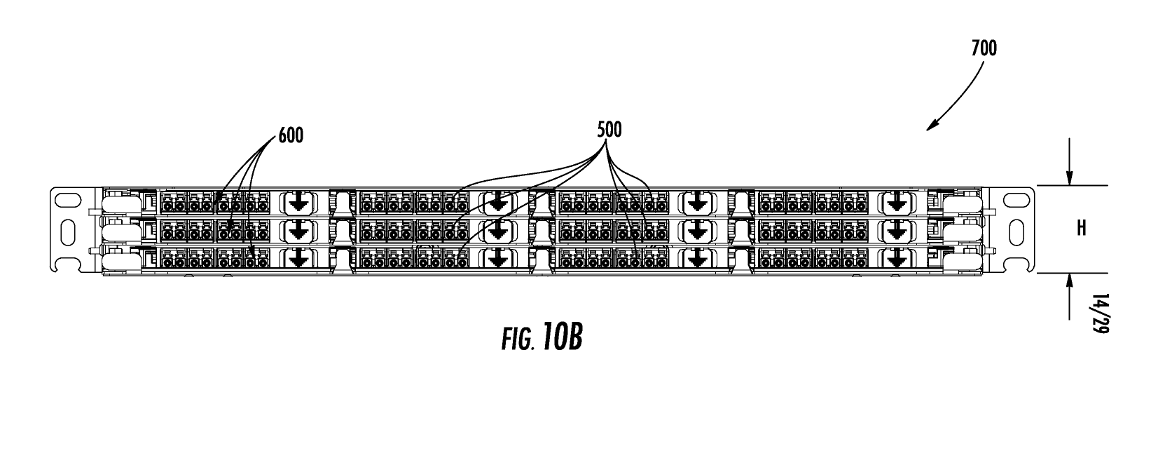

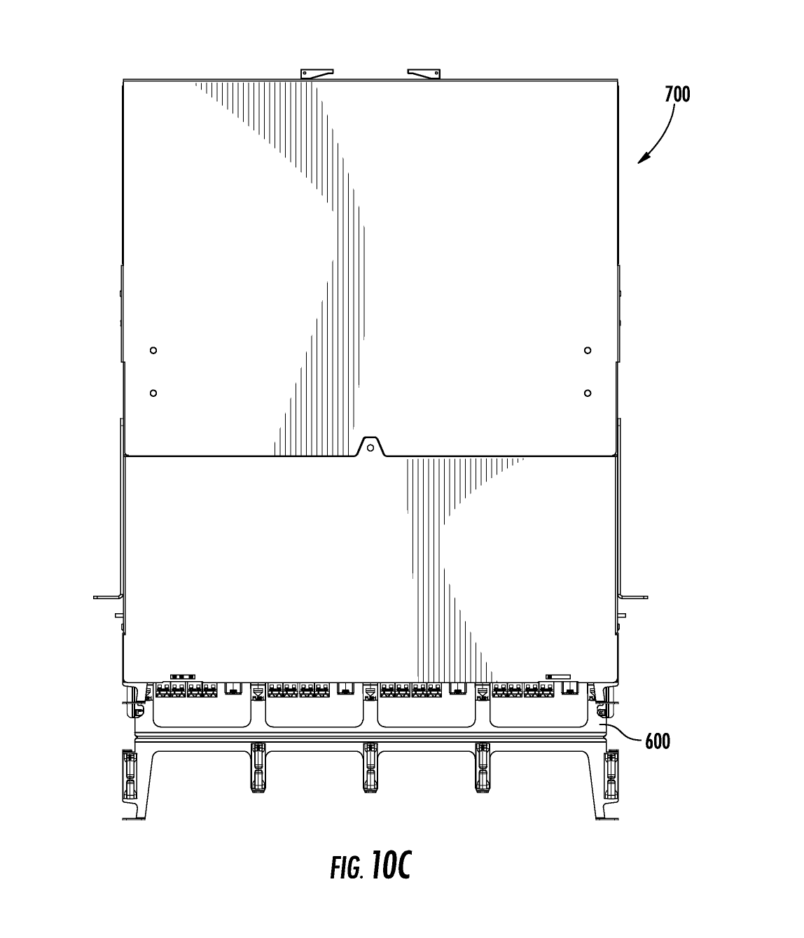

FIGS. 10A-10C depict tray assemblies with hybrid modules 500 installed and supported in a chassis 700. As shown, chassis 700 has a height H as 1-U space that accommodates three trays using a ⅓-U tray slot similar to chassis 300. FIG. 10B is a front view of the chassis 700 loaded with trays 600. Like chassis 300, trays 600 of chassis 700 are independently translatable. However, each tray 600 only supports four (4) hybrid modules 500. Thus, a chassis with a 1-U space will only accommodate twelve (12) hybrid modules 500, but provides an easy migration path between duplex and parallel transmission with 100% fiber utilization and does not add to the insertion loss budget.

FIGS. 10D and 10E illustrate respective perspective front views of different 4-U chassis implementations, consistent with certain disclosed embodiments. For example, FIG. 10D shows a 4-U chassis implementation having 12 ⅓ (or less) U-height trays, where each tray is configured to hold 6 independently-translatable modules. FIG. 10E shows a 4-U chassis implementation that includes one or more dividing members positioned vertically from the top of the chassis to the bottom of the chassis. As shown in FIG. 10E, the dividing members may be configured to slidably engage with individual modules, thereby eliminating the need for a tray. Each of the dividing members may include or embody a plurality of guide rails to support rails on the sides of the modules.

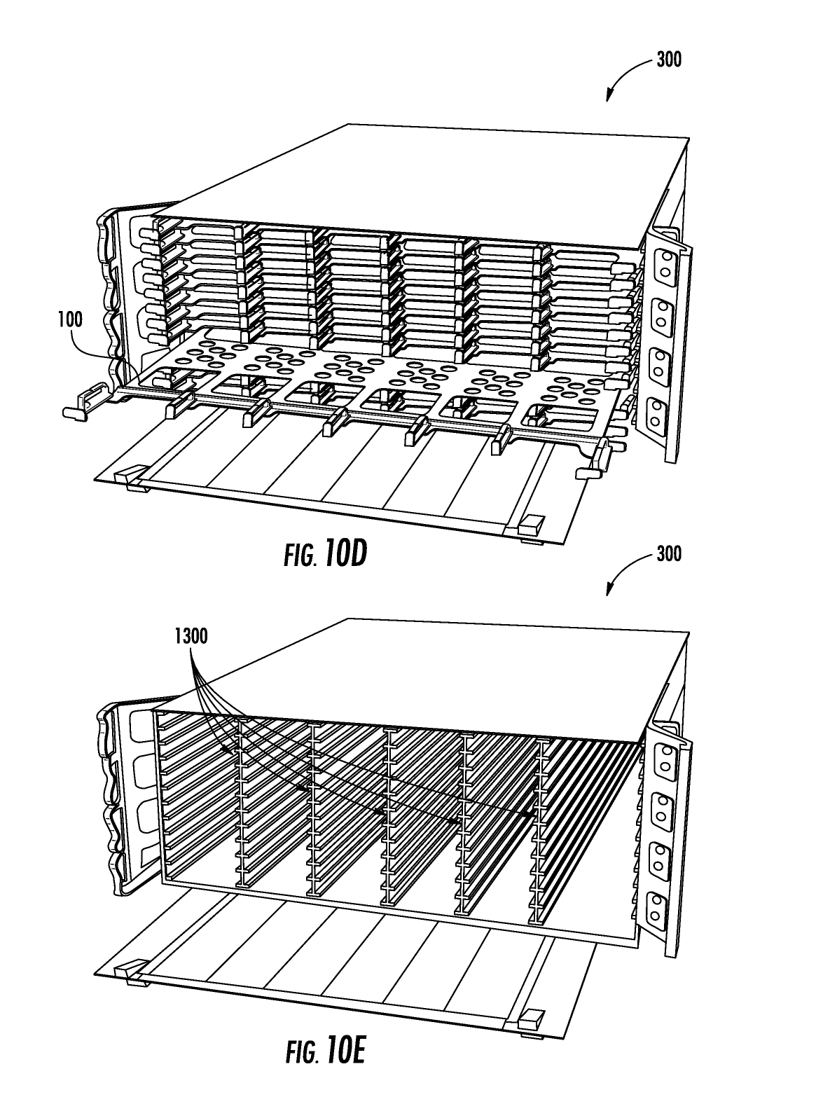

FIGS. 11A and 11B illustrate a perspective view of the rear of an alternate embodiment of a BASE-8 fiber optic module 10 and a perspective view of the front of an alternate embodiment of a BASE-8 fiber optic panel 400, consistent with certain disclosed embodiments. As illustrated in FIG. 11A, and similar to FIG. 1A, module 10 may include a front end and a rear end with a linear array of fiber optic adapters 18 disposed at the front end 12. The adapters are arranged in a width-wide direction in the front side in a BASE-8 configuration. Adapters 18 may be LC adapters and support an optical connection between an optical harness (not visible) within the module 10. The embodiment illustrated in FIG. 11A has four duplex LC adapters for eight LCs total; however, the adapters could be ganged together in other variations such as four LCs or eight LCs.

Module 10 may also comprise an enclosure (not numbered) with an internal cavity. The harness has a plurality of optical fibers optically connected between the linear array of fiber optic adapters 18 and a rear side of the fiber optic assembly. For instance, an MPO adapter 16 is disposed at rear end 14 suitable for connection with an 8-fiber connector of a trunk cable. However, other variations of module 10 are possible such as a pigtail extending from rear end 14 for optical connection.

Module 10 also has rails 22 for attaching it to a tray as discussed below. Module 10 may also comprise a lever 24 for selectively removing it from and securing it to a tray. For instance, a latch (not numbered) is disengaged by pushing lever 24 inward to release the latch (not numbered) from a support rail of the tray. To faciliate actuation of the lever 24, a finger tab 1112 may be disposed on the rear of module 10 and may be positioned at a predetermined lateral distance away from lever 24. According to the exemplary embodiment shown in FIG. 11A, finger tab 1112 may be positioned at the opposite side of module 10 from lever 24 and on the outside of fiber adapter 16, thereby providing added shielding and protection for adapter 16. According to one embodiment, and as illustrated in FIG. 11A, adapter 16 (shown as an MTP adapter) may be positioned toward the edge of module 10 to allow for convenient routing of the internal fiber optic harness. In other embodiments, adapter 16 may be positioned strategically along the rear of module 10, depending upon the desired routing configuration of the particular module.

During actuation of lever 24, opposably depress lever 24 and finger tab 1112 together, drawing lever 24 toward the finger tab 1112, thereby laterally displacing latch relative to a corresponding securing mechanism associated with the support rail of the tray and allowing the module to be slidably disengaged from the tray. According to some embodiments, module 10 may also include a stop tab 1110 positioned adjacent to or proximate lever 24 to provide a mechanism for limiting the lateral displacement of lever 24 to limit or reduce excess force being applied to lever 24. In some embodiments, one or more of lever 24, finger tab 1112 or stop tab 1110 may be “serrated” on one or more surfaces, providing for better grip during actuation.

FIG. 11B illustrates an exemplary fiber optic panel 440. As can be seen from FIG. 11B, panel assembly 400 comprises at least one pass-through channel configured to receive at least one optical multi-fiber cable therethrough. Panel assembly 400 may be used in a BASE-8 tray and may mount into a tray using ⅙ of the tray width or less; however, it may also be sized to fit into BASE-12 tray 3 if desired. Further, the panel assembly may be a part of a chassis and occupy 1/12 of a one U-space or less, for instance the panel assembly may be part of a chassis and occupy 1/18 of a one U-space or less.

Panel assembly 400 can have other features such as finger access cutouts (not explicitly shown in FIG. 11B) in the panel for allowing access below the panel assembly 400 to install BASE-8 connectors to adapters 418. Pass-through channel may have a cut-out so that a cable can be placed into the panel assembly 400 from the top side. Further, the pass-through channel may extend to the front end of the panel assembly and may include a second cut-out for placing cables into the panel assembly 400 from the top side. Panel assembly 400 may further include ribs for structural support, panel rails 422 for mounting in the tray, a lever 424, stop tab 1110, and/or finger tab 1112 or other suitable structure or features. Lever 424, stop tab 1110, and finger tab 1112 function similar to that described above with respect to FIG. 11A. Panel assembly can be configured as a simple panel or it can have a housing extending between a front panel and the rear end of panel assembly 400 as shown. It is possible for the housing to include an enclosure if desired to form a module.

Panel assembly 400 may include at least one front panel where the at least one front multi-fiber adapter 418 is disposed in the front panel. In the embodiment shown in FIG. 11B, panel assembly has four (4) front panels for the four (4) respective multi-fiber adapters 418. In other embodiments, the panel assembly 400 may include fewer or more than four panels.

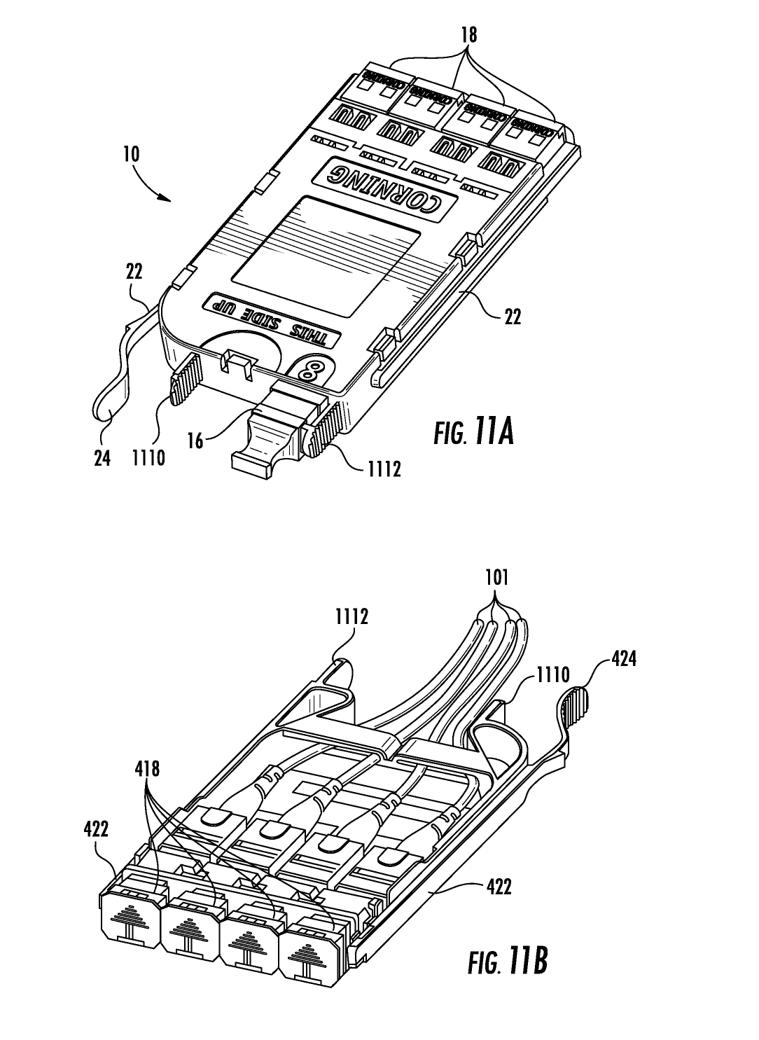

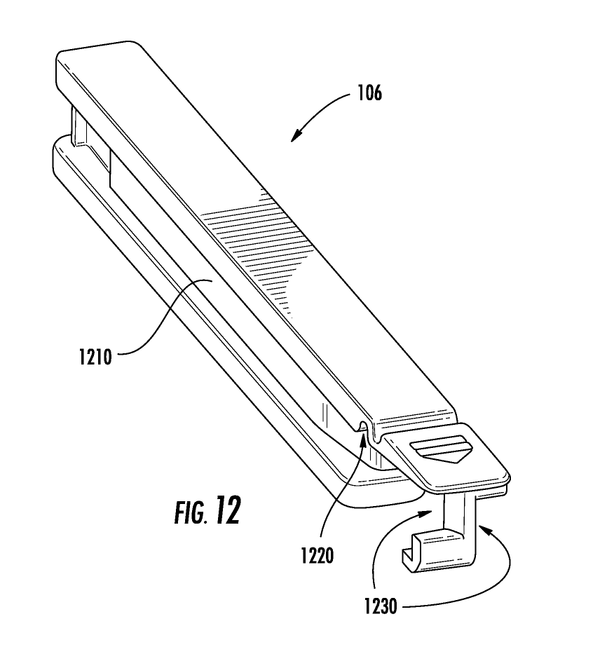

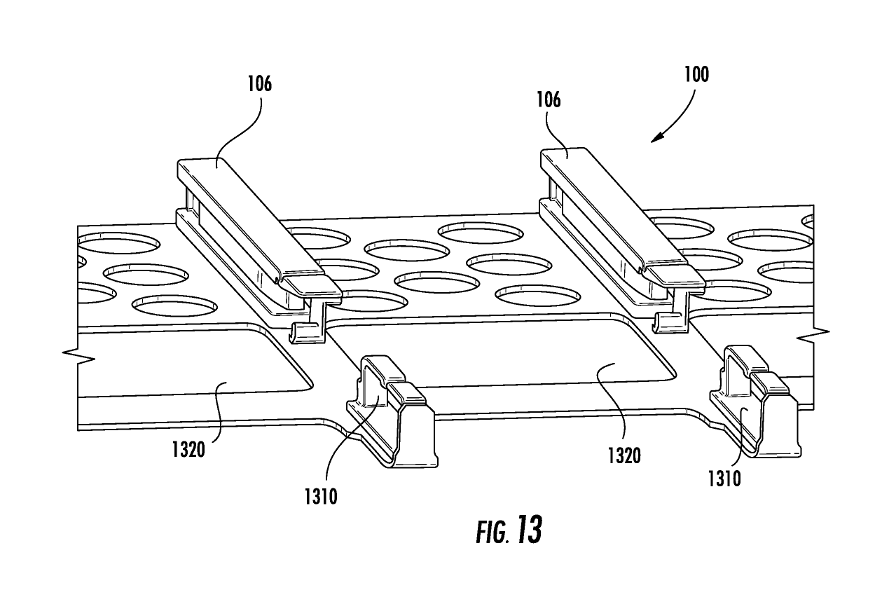

FIG. 12 illustrates a perspective view of an exemplary mounting rail 106 for use on a tray 100, in accordance with certain disclosed embodiments. FIG. 13 illustrates a perspective view of an exemplary tray 100 equipped with the exemplary mounting rails 106 of FIG. 12, consistent with certain disclosed embodiments. As illustrated in the embodiment of FIG. 12, mounting rail 106 may include a groove 1220 and chamfers 1230 disposed on the underside of the vertical beams of mounting rail 106, on both the left and right edge, at the front of the mounting rails 106. According to one embodiment, groove 1220 embodies a single groove that traverses the entire width of mounting rail 106. Alternative or additionally, mounting rail 106 may include multiple grooves 1220 (e.g., two), one of which extends laterally for a predetermined length (e.g., less than ½ of the total width of the vertical beam) from the right outside edge of the vertical beam toward the center of the vertical beam and one of which extends laterally for a predetermined length (e.g., less than ½ of the total width of the vertical beam) from the left outside edge of the vertical beam toward the center of the vertical beam. Chamfers 1230 may allow easier guide in and loading of modules and panels from the front of the tray 100. Enables single handed loading operation of the module or panel.

FIG. 13 illustrates a zoom-in, perspective front view of tray 100 with multiple mounting rails 106 of FIG. 12 for receiving a plurality of one or more of modules 10, panels 400, and combinations thereof, thereon. As illustrated in FIG. 13, tray 100 may include one or more access holes 1320. According to one embodiment, access holes 1320 may include or embody a rectangular opening in the bottom of the tray. In certain embodiments, access holes 1320 may be made wide enough to allow finger access to modules 10 from underneath tray, and to allow the shutters on panels 400 to rotate open greater than 90 degrees. Access holes 1320 are sized to correspond with the footprint of BASE-8 modules 10 and panels 400, but may be sized to support width of either hybrid panels or BASE-12 panels and BASE-8 simultaneously (or any combination thereof). As illustrated in FIG. 13, tray 100 may also include a plurality of cable routing guides 1310, each of which are mounted atop a respective routing guide support finger (not separately numbered) of tray 100.

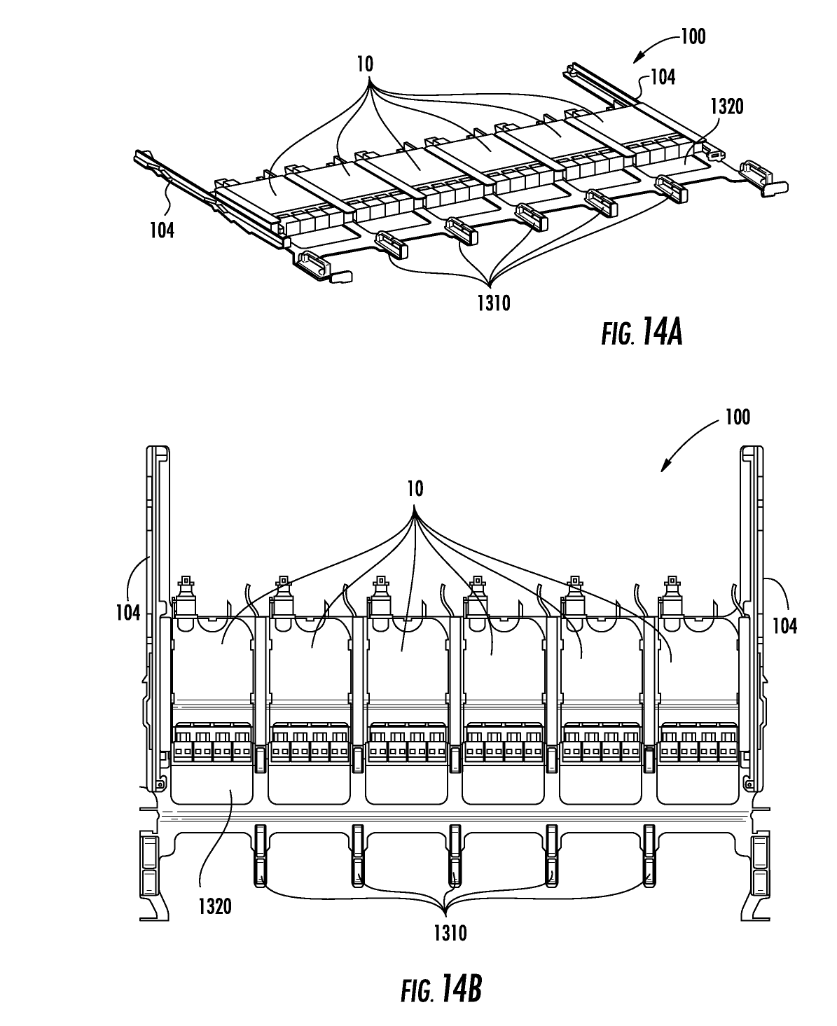

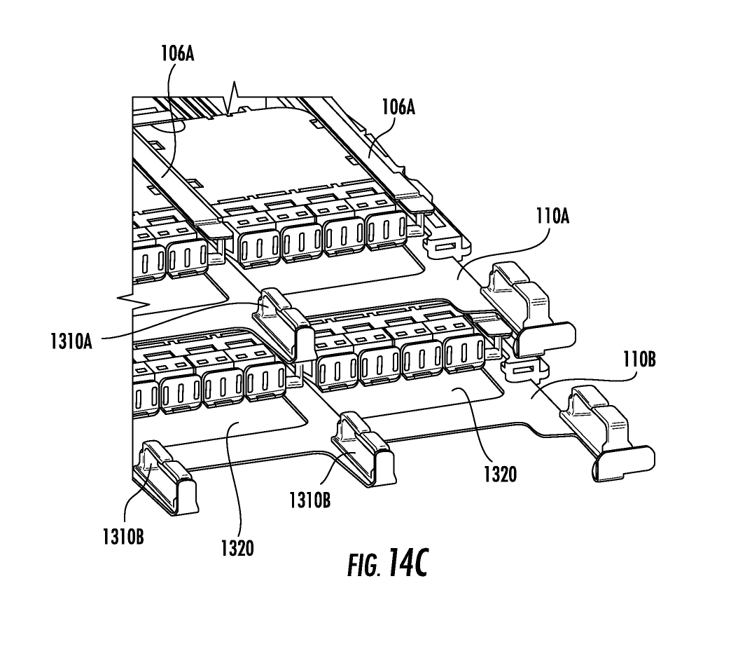

FIGS. 14A-14C illustrate perspective front, top, and close-up views, respectively, of an exemplary tray 100 for mounting fiber optic equipment. Tray 100 may be mounted in a chassis as disclosed or other suitable equipment. “Mounting” as the term is used here, refers to any component or group of componenets suitable for permanenently, semi-permanently, temporarily, and/or removably coupling tray 100 to the chassis. According to one embodiment, “mounting” may be effectuated by securing the tray 100 to the chassis using a permanent or semi-permanent fastener such as, for example, rivets, bolts, screws, or any other suitable mechanism (or combinations thereof) for fastening one structure to another. Alternatively or additionally, “mounting” may include or embodiment temporary or non-permanent solutions for securing tray 100 to the chassis. For example, in certain exemplary embodiments, mounting may be effectuated using clips, pull-tabs, removable rivets, press-clips, pine-tree type clips, push-nut fasteners, or any other type of fastener suitable for removably coupling tray 100 to chassis. “Mounting” may also include or embody any component or combinations of components suitable for slidably coupling tray 100 to the chassis. For example, tray 100 may be mounted to the chassis by way of a guide rail coupled to the chassis that, when coupled to a corresponding rail component of tray 100, supports and guides tray 100, allowing for forward-rearward translation of tray 100 relative to chassis.

Tray 100 comprises a base for supporting a plurality of BASE-8 fiber optic equipment. For instance, the tray can include module 10 and/or panel assembly 400 (FIG. 11B). The tray may comprise one or more support rails 104 of the base 102 for movably mounting the tray 100 in a chassis. The tray also comprises a plurality of equipment support rails 106 of the base for movably mounting the plurality of BASE-8 fiber optic equipment to the tray 100. Support rails and/or the equipment support rails may be modular components or may be integrally formed with the base of the tray as desired.

Base 102 is configured to support at least five (5) pieces of BASE-8 fiber optic equipment in a width W direction. Tray 100 has a height H of ⅓ U-Space or less. The tray may support a connection density of greater than thirty-two (32) fiber optic connections, at least forty (40) fiber optic connections, and forty-eight (48) fiber optic connections per ⅓ U-space with a BASE-8 configuration.

As depicted in FIGS. 14A-14C, the tray 100 is configured to support at least six pieces of BASE-8 fiber optic equipment equipment in the width-wise direction. Thus, module 10 is configured to mount into tray 100 using ⅙ of the tray width or less. The trays disclosed can be designed to be installable into existing installed base of chassis, thereby forming hybrid chassis having a first tray that supports BASE-8 fiber optic equipment and a second tray that supports BASE-12 fiber optic equipment such as shown by FIG. 5.

FIG. 15 illustrates a top view of an exemplary chassis assembly having a lower tray in an extended (“slid-out”) position and an upper tray in a fully retracted (“housed”) position, consistent with certain disclosed embodiments. As illustrated in FIG. 15, trays 100 may include a plurality of opposable tray pull tabs (not numbered) each of which protrudes from a respective front, lateral corner of tray 100. The clearance has been configured to allow finger access to the module release lever on the rail of the tray below, while allowing finger access deeper into the pull tab. According to one embodiment, the target finger/thumb-tip clearance is approximately 13 mm.

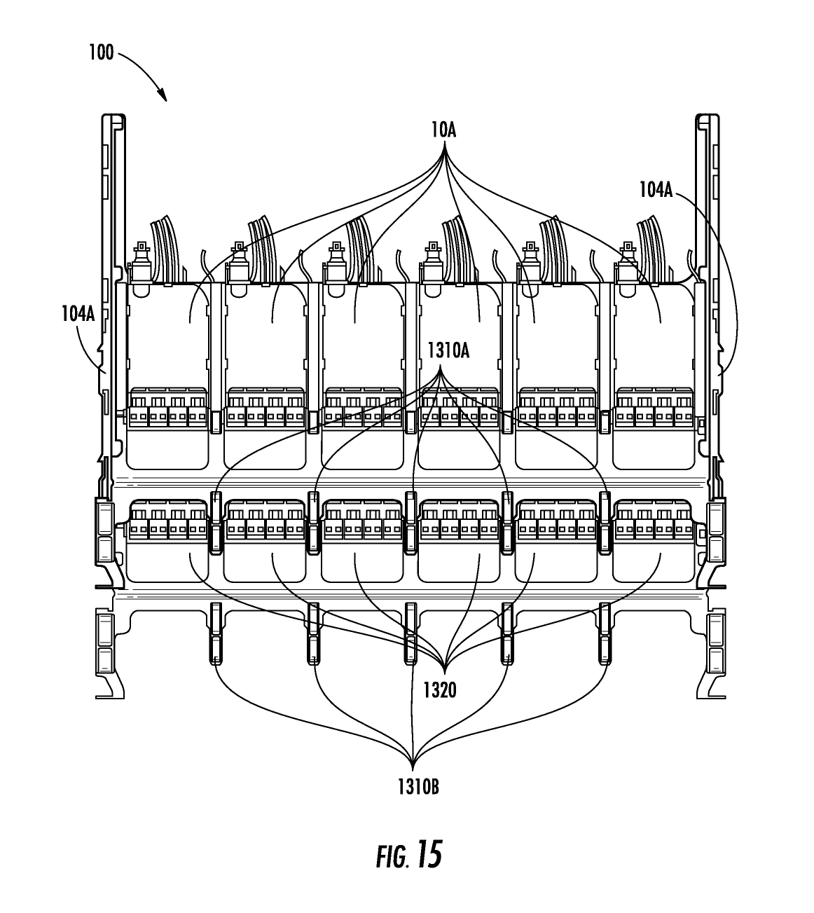

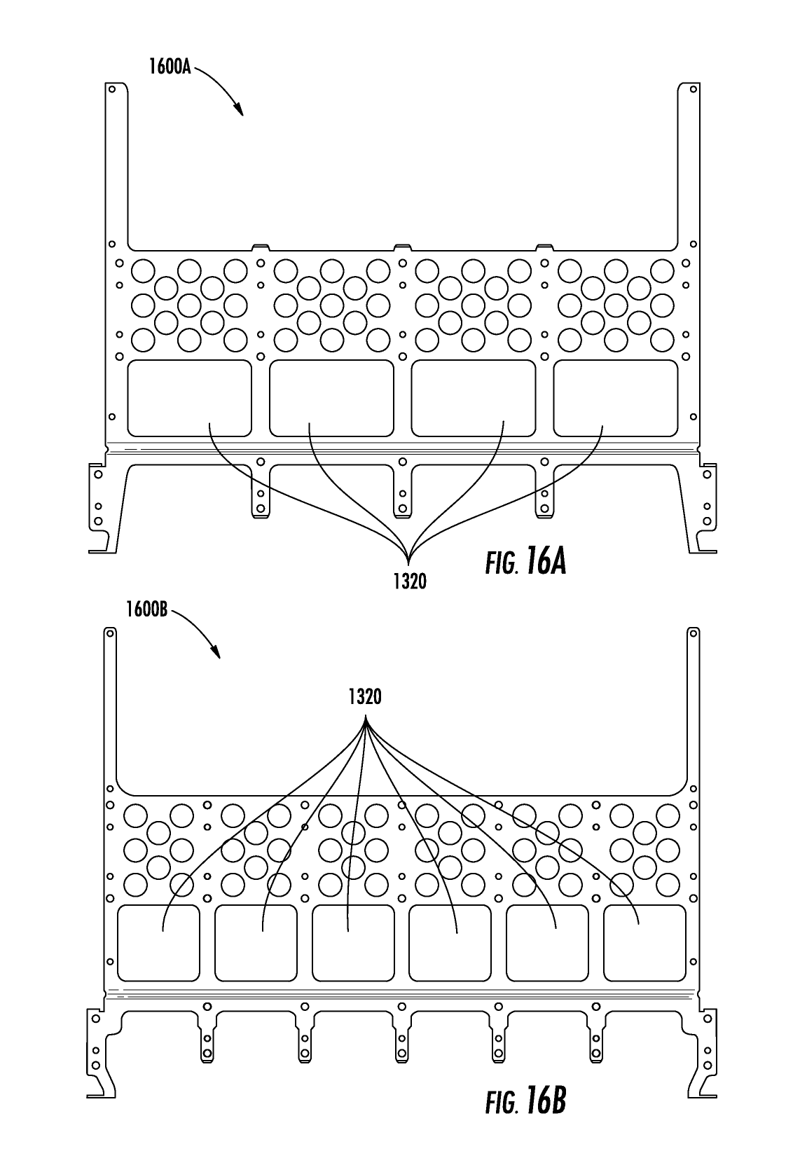

FIGS. 16A and 16B provide top views of alternate embodiments of metallic supporting structures used in respective implementations of the equipment trays, in accordance with certain disclosed embodiments. As shown in FIGS. 16A and 16B, tray 100 may include a plurality of routing guide support fingers (not separately numbered) that extend outwardly toward the front of tray 100 for supporting cable routing guides 1310. The metallic support structure of tray 100 corresponding to the routing guide support fingers is sized of thickness and length to provide for optimal hand and finger access to modules 10, panels 400, or other equipment associated with chassis. Similarly, the tray rail mounting support (not separately numbered) of tray 100, which extends toward the rear of the tray 100 from opposing lateral edges of tray 100, are also sized of thickness and length to allow access to the thumb release left rear and the finger tab right rear positions.

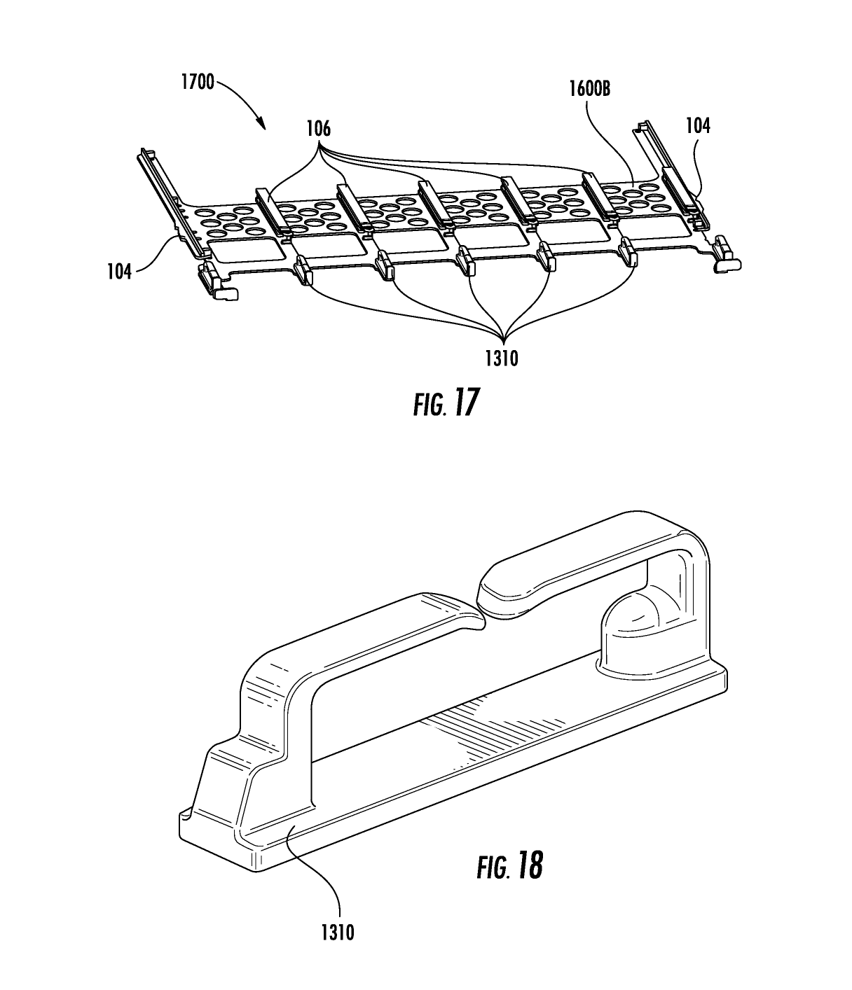

FIG. 17 illustrates a perspective front isometric view of an exemplary equipment tray having rail guides and jumper routing guides, consistent with certain disclosed embodiments. FIG. 18 illustrates a perspective side view of an exemplary jumper routing guide, in accordance with certain disclosed embodiments.

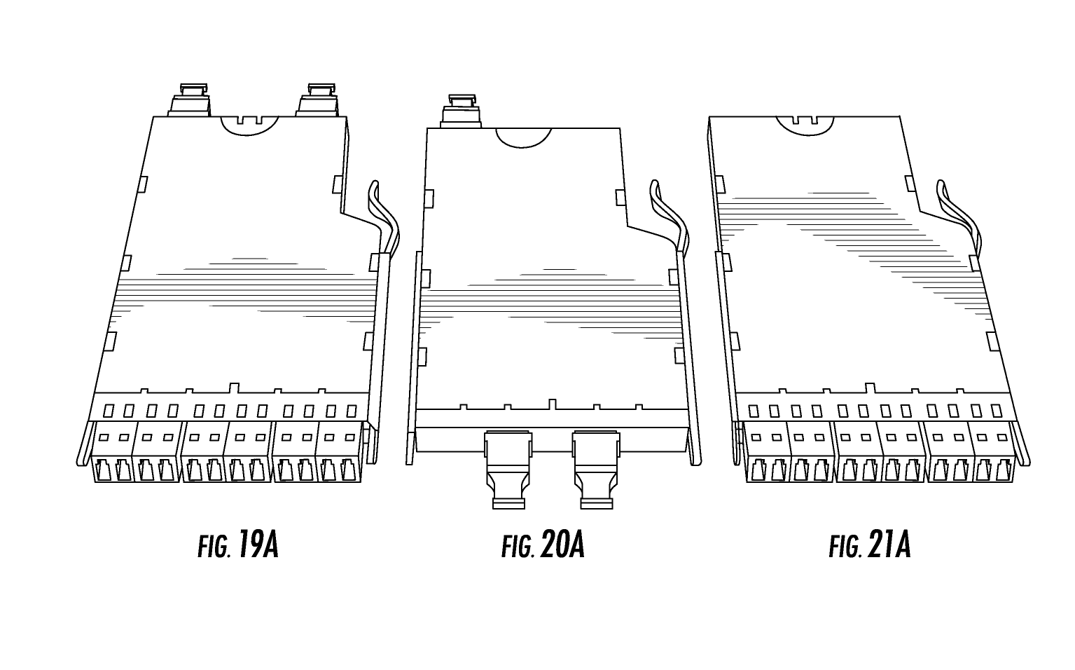

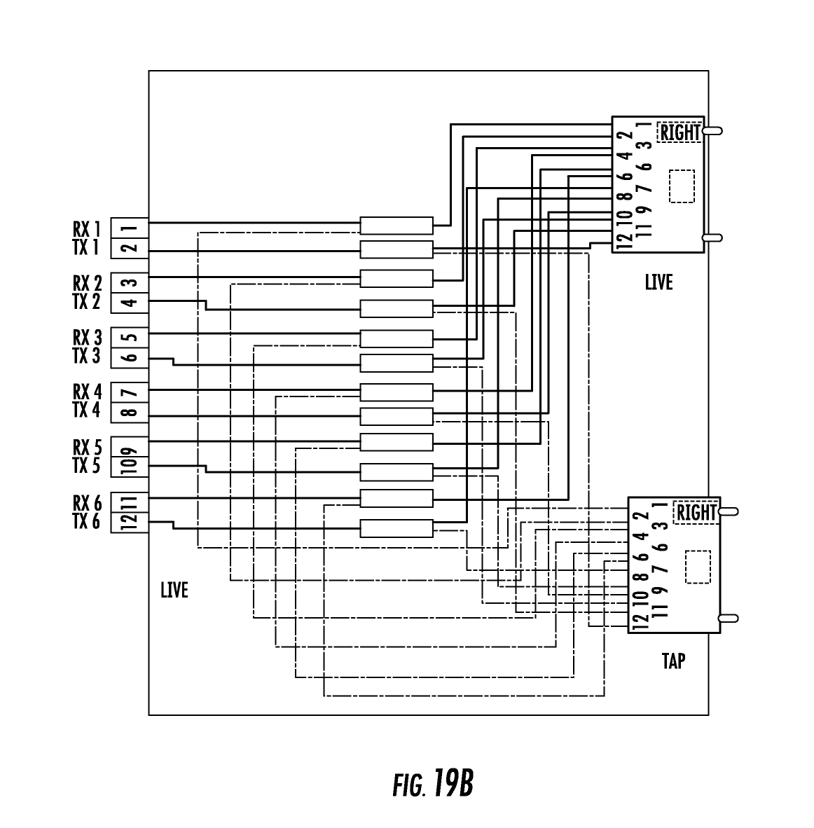

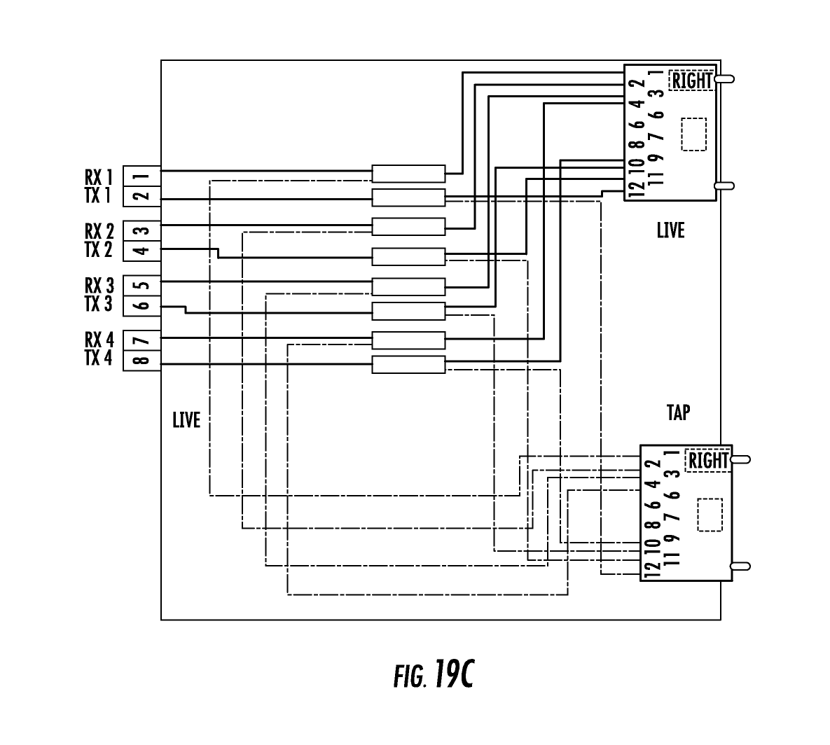

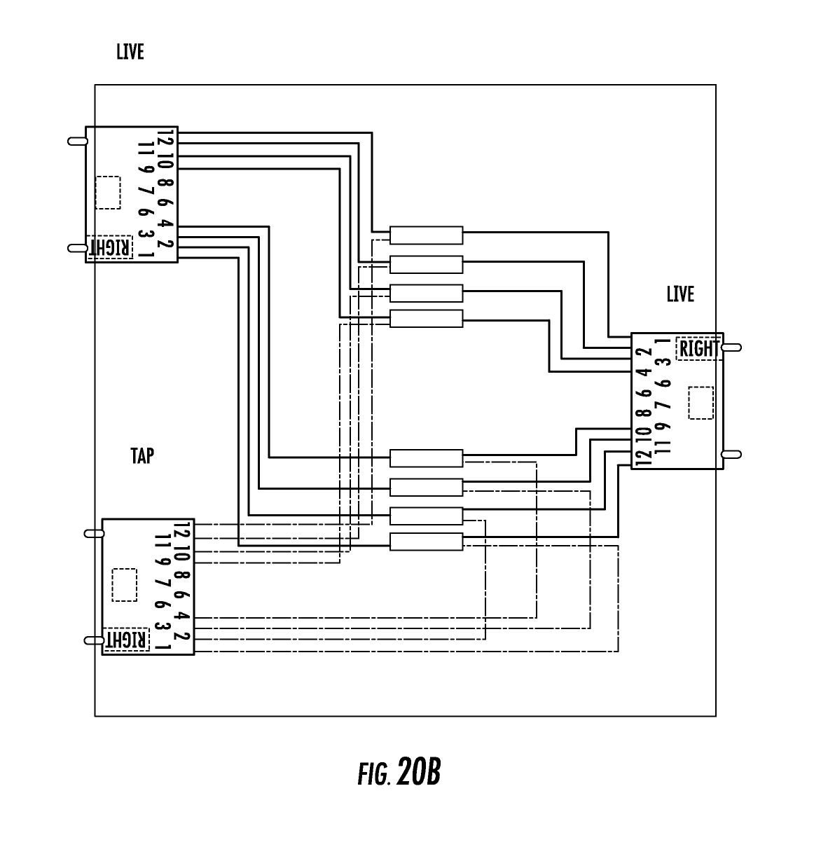

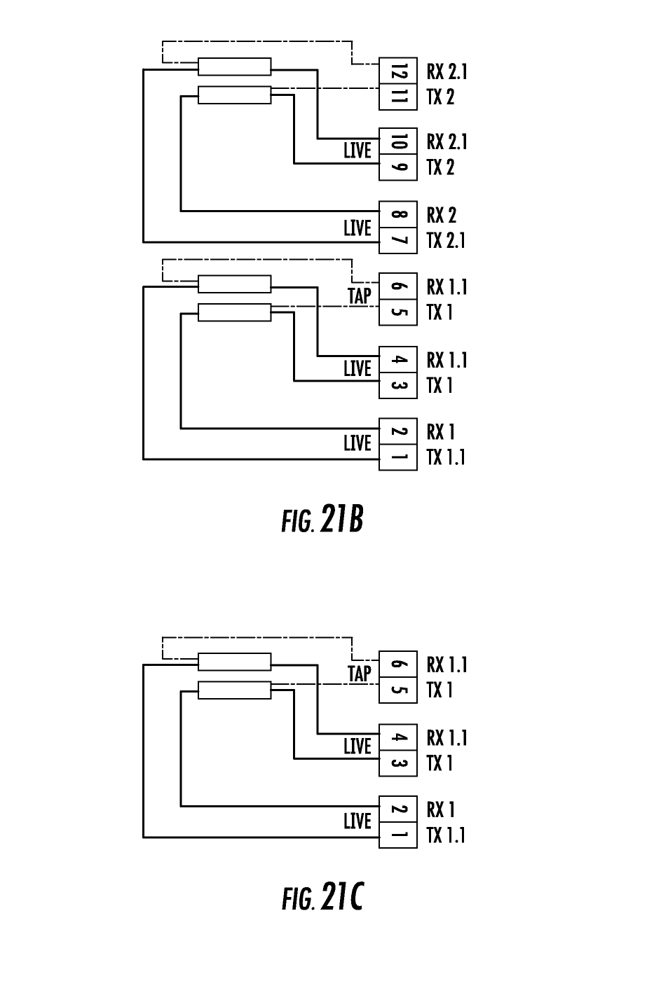

FIGS. 19A, 19B, and 19C illustrate a perspective front view (for BASE-12), a schematic wiring diagram (for BASE-12), and a schematic wiring diagram (for BASE-8), respectively, of exemplary LC to MTP module with an MTP port “tap” capability. FIGS. 20A and 20B illustrate a respective perspective front view and schematic wiring diagram, respectively, of an exemplary BASE-12 and BASE-8 MTP to MTP module with an MTP port “tap” capability illustrate a perspective front view and schematic wiring diagram, respectively, of an exemplary BASE-8 MTP to MTP module with an MTP port “tap” capability. FIGS. 21A, 21B, and 21C illustrate a perspective front view (for BASE-12), a schematic wiring diagram (for BASE-12), and a schematic wiring diagram (for BASE-8), respectively, of exemplary LC to LC port “tap” capability.

It should be noted that, although certain embodiments are shown and illustrated with each tray 100 occupying the entire width of chassis, it is contemplated that the embodiments described herein contemplate embodiments in which a plurality of trays are used to populate the width of chassis. For example, rather than having three trays, each designed to occupy the width (or less) and ⅓ of the height (or less) of a 1-U chassis, the chassis may be designed to support configurations with 6 trays, each designed to occupy ½ of the width (or less) and ⅓ of the height (or less) of a 1-U chassis. In these embodiments, chassis may include one or more dividing members, positioned vertically from the top of the chassis to the bottom of the chassis disposed at approximately the horizontal mid-point of the chassis, wherein the dividing member having a plurality of guide rails to support rails on the sides of the trays. Such a design would provide flexibility to support different sizes of BASE modules in the same row. For example, one half of the row can be configured to support 3 BASE-8 modules and the other half of the row can be configured to accommodate 2 BASE-12 modules, enabling a greater degree of customization.

The concepts and fiber optic equipment disclosed provide flexibility for the network operators to modify the optical network architecture as need to migrate between duplex and parallel transmission as desired. Moreover, the trays and assemblies may be backwards compatible to fit into an installed chassis base that network operators may already be using.

Unless otherwise expressly stated, it is in no way intended that any method set forth herein be construed as requiring that its steps be performed in a specific order. Accordingly, where a method embodiment does not actually recite an order to be followed by its steps or it is not otherwise specifically stated in the embodiments or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended embodiments and their equivalents.

What is claimed is:

1. A hybrid fiber optic module having a front end and a rear end:
a linear array of single fiber optical connector adapters arranged in a width direction at the front end, each of the single fiber optical adapters having a front side and a rear side;
a front multi-fiber adapter at the front end, the front multi-fiber adapter having a front side and a rear side;
a rear multi-fiber adapter at the rear end of the module, the rear multi-fiber adapter having a front side and a rear side; and
a plurality of optical fibers optically connected between a rear side of each of the array of single fiber optic adapters and the front side of the rear multi-fiber adapter;
wherein a multi-fiber connector can be connected to either the rear side of the front multi-fiber adapter to enable an optical connection with a multi-fiber connector connected to the front side of the front multi-fiber adapter, or to the rear side of the rear multi-fiber adapter to enable optical connections with a plurality of single fiber optic connectors connected to the linear array of single fiber fiber optic connector adapters.

2. The hybrid fiber optic module of claim 1, wherein the linear array of single fiber optic adapters support eight (8) single fiber connectors.

3. The hybrid fiber optic module of claim 2, further comprising a housing partially extending between the front end and the rear end of the hybrid fiber optic module, and the housing having mounting structure.

4. The hybrid fiber optic module of claim 3, wherein the housing comprises an enclosure enclosing the plurality of optical fibers.

5. The hybrid fiber optic module of claim 4, wherein the front multi-fiber adapter is disposed outside the enclosure.

6. The hybrid fiber optic module of claims 1, further comprising at least one pass-through channel extending from the rear side of the front multi-fiber adapter to the rear end of the hybrid fiber optic module.

7. The hybrid fiber optic module of claim 6, further comprising at least one cable management feature proximate to the at least one pass-through channel, the at least one cable management feature configured to retain the fiber optic cable in the channel.

8. The hybrid fiber optic module of claim 1, wherein the single fiber optical connector adapters comprise LC fiber optic adapters.

9. The hybrid fiber optic module of claim 1, further including a finger access cutout for the rear side of the front multi-fiber adapter.

10. The hybrid fiber optic module of claim 1, wherein the hybrid fiber optic assembly is configured to mount into a tray using ¼ of the tray width or less.

11. The hybrid fiber optic module of claim 1, wherein the hybrid fiber optic assembly has a height that is ⅓ U-space or less.
